(19) United States
(12) Patent Application Publication
(10) Pub. No.: US 2010/0053239 A1
(43) Pub. Date: Mar. 4, 2010

(54) LIQUID APPLICATION APPARATUS AND METHOD, AND INKJET RECORDING APPARATUS

(76) Inventor: Koji FURUKAWA, Ashigarakami-gun (JP)

Correspondence Address: BIRCH STEWART KOLASCH & BIRCH, PO BOX 747, FALLS CHURCH, VA, 22040-0747, US

(21) Appl. No.: 12/549,796

(22) Filed: Aug. 28, 2009

(30) Foreign Application Priority Data
Aug. 29, 2008 (JP) 2008-221572

(51) Int. Cl. B41J 29/38; B41J 2/015

(52) U.S. Cl. 347/6; 347/20

(57) ABSTRACT

The liquid application apparatus includes: a drum which holds a sheet-shaped recording medium on a circumferential surface thereof and rotationally conveys the recording medium; a belt which is wrapped about at least a pair of rollers and makes contact with the recording medium held on the circumferential surface of the drum and rotationally conveyed; a belt travel device which causes the belt to travel; and an application liquid supply device which supplies an application liquid to a circumferential surface of the belt. The application liquid supplied to the circumferential surface of the belt is applied to the recording medium through the belt.

### BACKGROUND OF THE INVENTION

1. Field of the Invention

The present invention relates to a liquid application apparatus, a liquid application method and an inkjet recording apparatus, and more particularly to a liquid application apparatus and a liquid application method for applying a treatment liquid containing an aggregating agent onto a recording medium prior to deposition of ink droplets in an inkjet recording system, and an inkjet recording apparatus using the same.

2. Description of the Related Art

An inkjet recording apparatus forms an image on a recording medium by successively depositing droplets of ink onto the recording medium. The inkjet recording apparatus is able to record images of good quality by means of a simple composition, and therefore such apparatuses are widely used as domestic printers for individual use and office printers for commercial use. In the case of office printers for commercial use, in particular, there are increasing demands for higher processing speed and higher image quality.

In the inkjet recording apparatus, if droplets of ink are deposited on a recording medium to form mutually adjacent dots in a superimposed fashion, the ink droplets on the recording medium combine together due to their surface tension and a problem of bleeding (landing interference) occurs in which it is not possible to form desired dots. Bleeding gives rise to disturbance of the dot shape, if the dots are of the same color, and also gives rise to color mixing if the dots are of different colors.

Therefore, a method has been proposed in which a treatment liquid containing an aggregating component is firstly deposited on a recording medium, whereupon droplets of ink are deposited and caused to aggregate. According to this method, since the ink aggregates due to the aggregating component in the treatment liquid, it is possible to suppress interference between the ink droplets and it is also possible to eliminate problems of bleeding, and the like.

Japanese Patent Application Publication No. 2007-083180 discloses a treatment liquid application apparatus that applies treatment liquid to a recording medium using an application roller. Japanese Patent Application Publication No. 2002-320890 discloses a treatment liquid application apparatus that applies treatment liquid to a recording medium using a roller which rotates in the opposite direction to the direction of travel of the recording medium.

However, the methods described in Japanese Patent Application Publication Nos. 2007-083180 and 2002-320890 produce application non-uniformities when the treatment liquid is applied, and consequently there has been a problem of the occurrence of non-uniformities in the aggregation of the ink. Moreover, in Japanese Patent Application Publication No. 2002-320890, although it is possible to carry out suitable application onto a recording medium in the form of a web, in the case of sheet-shaped recording media there are problems such as the occurrence of conveyance errors, and damaging of the recording medium by the roller.

### SUMMARY OF THE INVENTION

The present invention has been contrived in view of the circumstances described above, an object thereof being to provide a liquid application apparatus, a liquid application method and an inkjet recording apparatus, whereby it is possible to prevent damaging of sheet-shaped recording media and application non-uniformities.

In order to attain the aforementioned object, the present invention is directed to a liquid application apparatus, comprising: a drum which holds a sheet-shaped recording medium on a circumferential surface thereof and rotationally conveys the recording medium; a belt which is wrapped about at least a pair of rollers and makes contact with the recording medium held on the circumferential surface of the drum and rotationally conveyed; a belt travel device which causes the belt to travel; and an application liquid supply device which supplies an application liquid to a circumferential surface of the belt, wherein the application liquid supplied to the circumferential surface of the belt is applied to the recording medium through the belt.

According to this aspect of the present invention, since the application liquid is supplied to the travelling belt and this belt is made to contact the recording medium, then the application liquid is applied to the recording medium through the belt. When the application liquid is thus applied to the recording medium through the belt, it is possible to carry out uniform application, even in the case of the recording medium which is rotationally conveyed on the drum. In other words, in the case of the recording medium which is rotationally conveyed on the drum, it is difficult to apply the application liquid uniformly, for example, if the liquid is applied with a roller, then not only does the application liquid become non-uniform, but there is also a risk of damage to the recording medium due to the pressure of the roller. In response to this, according to this aspect of the present invention, the application liquid is applied through the belt to the recording medium which is rotationally conveyed on the drum, and therefore the belt is pressed against the recording medium in a substantially uniform fashion and it is possible to apply the application liquid uniformly, in addition to which it is possible to prevent errors in the conveyance of the recording medium and damage to the recording medium.

Preferably, the belt travel device causes the belt to travel in a direction opposite to a conveyance direction of the recording medium. According to this aspect of the present invention, the belt is made to travel in the direction opposite to the conveyance direction of the recording medium, and therefore it is possible to improve the condition of the surface of the application liquid. In other words, if the belt is made to travel in the same direction as the conveyance direction of the recording medium, then there is a risk that air bubbles will occur due to the release of pressure when the belt and the recording medium are separated, but in this aspect of the present invention, this can be prevented.

Preferably, the application liquid supply device includes a metering roller which is disposed so as to contact the belt and rotates in a rotational direction opposite to a travel direction of the belt, the application liquid held on a surface of the metering roller being transferred to the circumferential surface of the belt. According to this aspect of the present invention, since the application liquid is measured out and supplied to the belt, it is possible to apply a desired amount of the application liquid to the recording medium.

Preferably, the application liquid supply device further includes a first doctor blade which scrapes off an excess of the application liquid on the surface of the metering roller, the first doctor blade being disposed to an upstream side of a point of contact between the belt and the metering roller in terms of the rotational direction of the metering roller. According to this aspect of the present invention, the application liquid can be accurately measured out and supplied to the belt.

Preferably, the application liquid supply device further includes a second doctor blade which scrapes off the application liquid on the circumferential surface of the belt, the second doctor blade being disposed to an upstream side of the point of contact between the belt and the metering roller in terms of the travel direction of the belt. According to this aspect of the present invention, it is possible to accurately control the amount of the application liquid conveyed on the belt

Preferably, the liquid application apparatus further comprises a separating device which separates the belt from the circumferential surface of the drum. According to this aspect of the present invention, since the separating device is provided which separates the belt from the circumferential surface of the drum, then it is possible to separate the belt from the circumferential surface of the drum, for instance, if there is no recording medium.

Preferably, the belt is an embossed belt having recesses and projections in the circumferential surface thereof. According to this aspect of the present invention, even if a metering roller is not used, it is possible to supply a desired amount of the application liquid to the recording medium by means of the embossed belt.

Preferably, the application liquid supply device includes a doctor blade which scrapes off an excess of the application liquid on the circumferential surface of the belt, the doctor blade being disposed to an upstream side of a point of contact between the belt and the recording medium in terms of the travel direction of the belt. According to this aspect of the present invention, the application liquid can be accurately measured out and supplied to the recording medium.

In order to attain the aforementioned object, the present invention is also directed to an inkjet recording apparatus, comprising: a drum which holds a sheet-shaped recording medium on a circumferential surface thereof and rotationally conveys the recording medium; an endless belt which is wrapped about at least a pair of rollers and makes contact with the recording medium held on the circumferential surface of the drum and rotationally conveyed; a belt travel device which causes the belt to travel; a treatment liquid supply device which supplies a treatment liquid to a circumferential surface of the belt; and an ink ejection device which ejects ink having a solid component that aggregates or precipitates by making contact with the treatment liquid, onto the recording medium on which the treatment liquid has been deposited.

According to this aspect of the present invention, since the treatment liquid is applied to the recording medium through the belt, then it is possible to apply the treatment liquid uniformly to the recording medium. Consequently, it is possible to cause the ink to aggregate or precipitate uniformly, when depositing the ink.

In order to attain the aforementioned object, the present invention is also directed to a liquid application method, comprising the steps of: supplying an application liquid to a surface of a travelling belt; causing the surface of the belt to which the application liquid has been supplied to make contact with a sheet-shaped recording medium held on a circumferential surface of a drum and rotationally conveyed; and applying thereby the application liquid to the recording medium through the belt.

According to this aspect of the present invention, the application liquid is applied to the recording medium by supplying the application liquid to the travelling belt and causing this belt to make to contact with the recording medium. According to this application method, since the belt makes contact in a substantially uniform fashion with the recording medium, then it is possible to apply the application liquid to the recording medium without non-uniformities, and it is also possible to prevent errors in the conveyance of the recording medium or damage to the recording medium.

Preferably, the supplying step includes the step of metering the application liquid to be supplied onto the surface of the belt.

Preferably, the supplying step includes the step of metering the application liquid that has been supplied on the surface of the belt.

According to the present invention, application liquid is applied by bringing a belt supplied with the application liquid into contact with a recording medium, and therefore it is possible to prevent the occurrence of application non-uniformities, or errors in the conveyance of the recording medium or damage to the recording medium.

### BRIEF DESCRIPTION OF THE DRAWINGS

The nature of this invention, as well as other objects and advantages thereof, will be explained in the following with reference to the accompanying drawings, in which like reference characters designate the same or similar parts throughout the figures and wherein:

FIG. 1 is a schematic structural diagram illustrating an inkjet printing apparatus according to an embodiment of the present invention;

FIGS. 2A and 2B are schematic structural diagrams illustrating a treatment liquid application apparatus according to the first embodiment of the present invention;

FIG. 3 is a schematic structural diagram illustrating a treatment liquid application apparatus according to the second embodiment of the present invention;

FIG. 4 is a schematic structural diagram illustrating a treatment liquid application apparatus according to the third embodiment of the present invention;

FIG. 5 is a schematic structural diagram illustrating a treatment liquid application apparatus according to the fourth embodiment of the present invention;

FIG. 6A is a plan perspective view of principal components illustrating the internal structure of a head, and FIG. 6B is an enlarged view of part thereof;

FIG. 7 is a plan view illustrating another configuration example of the head;

FIG. 8 is a cross-sectional view along line 8-8 in FIGS. 6A and 6B;

FIG. 9 is a plan view illustrating a nozzle arrangement example in the head; and

FIG. 10 is a principal block diagram illustrating the system configuration of the inkjet recording apparatus.

### DETAILED DESCRIPTION OF THE PREFERRED EMBODIMENTS

A treatment liquid application device provided in an inkjet recording apparatus is hereby described as a liquid application apparatus according to an embodiment of the present invention; however, the present invention is not limited to this embodiment. General Composition of Inkjet Recording Apparatus Firstly, the overall composition of an inkjet recording apparatus according to an embodiment of the present invention will be described.

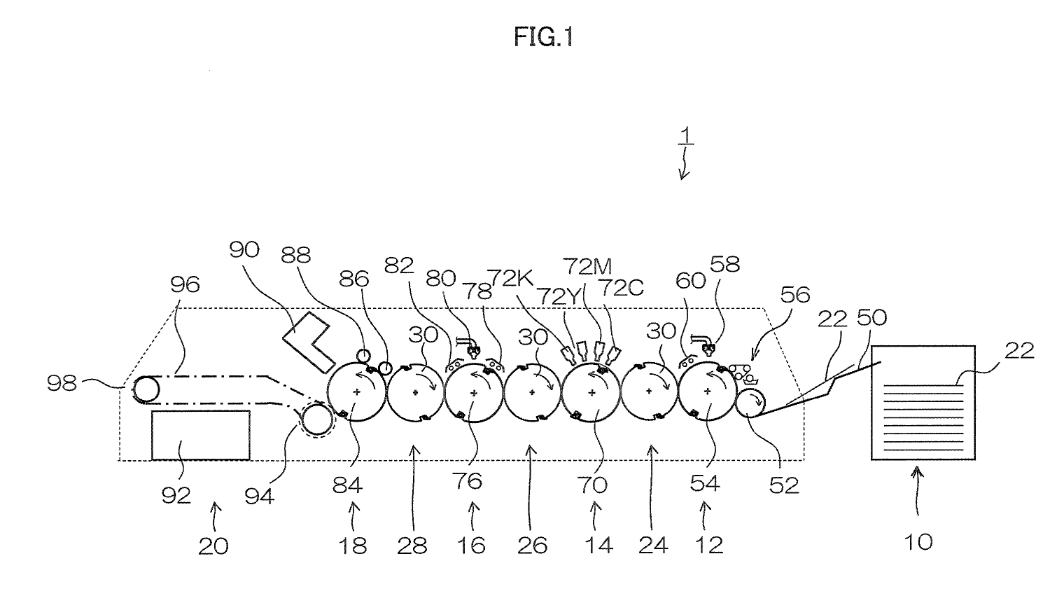

FIG. 1 is a structural diagram illustrating the entire configuration of an inkjet recording apparatus 1 of the present embodiment. The inkjet recording apparatus 1 shown in the drawing forms an image on a recording surface of a recording medium 22. The inkjet recording apparatus 1 includes a paper feed unit 10, a treatment liquid application unit 12, an image formation unit 14, a drying unit 16, a fixing unit 18, and a discharge unit 20 as the main components. A recording medium 22 (paper sheets) is stacked in the paper feed unit 10, and the recording medium 22 is fed from the paper feed unit 10 to the treatment liquid application unit 12. A treatment liquid is applied to the recording surface in the treatment liquid application unit 12, and then a color ink is applied to the recording surface in the image formation unit 14. The image is fixed with the fixing unit 18 on the recording medium 22 onto which the ink has been applied, and then the recording medium is discharged with the discharge unit 20.

In the inkjet recording apparatus 1, intermediate conveyance units 24, 26, 28 are provided between the units, and the recording medium 22 is transferred by these intermediate conveyance units 24, 26, 28. Thus, a first intermediate conveyance unit 24 is provided between the treatment liquid application unit 12 and image formation unit 14, and the recording medium 22 is transferred from the treatment liquid application unit 12 to the image formation unit 14 by the first intermediate conveyance unit 24. Likewise, the second intermediate conveyance unit 26 is provided between the image formation unit 14 and the drying unit 16, and the recording medium 22 is transferred from the image formation unit 14 to the drying unit 16 by the second intermediate conveyance unit 26. Further, a third intermediate conveyance unit 28 is provided between the drying unit 16 and the fixing unit 18, and the recording medium 22 is transferred from the drying unit 16 to the fixing unit 18 by the third intermediate conveyance unit 28.

Each unit (paper feed unit 10, treatment liquid application unit 12, image formation unit 14, drying unit 16, fixing unit 18, discharge unit 20, and first to third intermediate conveyance units 24, 26, 28) of the inkjet recording apparatus 1 will be described below in greater details.

### <Paper Feed Unit>

The paper feed unit 10 is a mechanism that feeds the recording medium 22 to the image formation unit 14. A paper feed tray 50 is provided in the paper feed unit 10, and the recording medium 22 is fed, sheet by sheet, from the paper feed tray 50 to the treatment liquid application unit 12.

### <Treatment Liquid Application Unit>

The treatment liquid application unit 12 is a mechanism that applies a treatment liquid to the recording surface of the recording medium 22. The treatment liquid includes a coloring material aggregating agent that causes the aggregation or precipitation of a coloring material (pigment) included in the ink applied in the image formation unit 14, and the separation of the coloring material and a solvent in the ink is enhanced when the treatment liquid is brought into contact with the ink. The treatment liquid is described in detail later.

As shown in FIG. 1, the treatment liquid application unit 12 includes a transfer drum 52, a treatment liquid drum 54, a treatment liquid application device 56, a warm-air blow-out nozzle 58, and an IR (infrared) heater 60. The transfer drum 52 is disposed between the paper feed tray 50 of the paper feed unit 10 and the treatment liquid drum 54, and is driven to rotate. The recording medium 22 fed from the paper feed unit 10 is received by the transfer drum 52 and transferred to the treatment liquid drum 54. The below-described intermediate conveyance unit may be also provided instead of the transfer drum 52.

The treatment liquid drum 54 is a drum that holds and rotationally conveys the recording medium 22. The treatment liquid drum 54 is driven to rotate. The treatment liquid drum 54 is provided on the outer peripheral surface thereof with a hook-shaped holding device, by which the leading end of the recording medium 22 is held. In a state in which the leading end of the recording medium 22 is held by the holding device, the treatment liquid drum 54 is rotated to convey rotationally the recording medium. In this case, the recording medium 22 is conveyed so that the recording surface thereof faces outside. The treatment liquid drum 54 may be provided with suction holes on the outer peripheral surface thereof and connected to a suction device that performs suction from the suction holes. As a result, the recording medium 22 can be tightly held on the circumferential surface of the treatment liquid drum 54.

The treatment liquid application device (corresponding to the application device according to the present invention) 56, the warm-air blow-out nozzle 58, and the IR heater 60 are provided on the outside of the treatment liquid drum 54 opposite the circumferential surface thereof. The treatment liquid application device 56, warm-air blow-out nozzle 58, and IR heater 60 are installed in the order of description from the upstream side in the rotation direction (counterclockwise direction in FIG. 1) of the treatment liquid drum 54. First, the treatment liquid is applied on the recording surface of the recording medium 22 by the treatment liquid application device 56. In this case, it is preferred that the film thickness of the treatment liquid be sufficiently smaller than the diameter of ink droplets that are deposited from ink heads 72C, 72M, 72Y, 72K of the image formation unit 14. For example, when the ink droplet volume is 2 picoliters (pl), the average diameter of the droplet is 15.6 μm. In this case, when the film thickness of the treatment liquid is large, the ink dot will be suspended in the treatment liquid, without coming into contact with the surface of the recording medium 22. Accordingly, when the ink droplet volume is 2 pl, it is preferred that the film thickness of the treatment liquid be not more than 3 μm in order to obtain a landing dot diameter not less than 30 μm.

The recording medium 22 that has been coated with the treatment liquid in the treatment liquid application device 56 is conveyed to the location of the warm-air blow-out nozzle 58 and the IR heater 60. The warm-air blow-out nozzle 58 is configured to blow hot air at a high temperature (for example, 70° C.) at a constant blowing rate (for example, 9 m³/min) toward the recording medium 22, and the IR heater 60 is controlled to a high temperature (for example, 180° C.). Water included in the solvent of the treatment liquid is evaporated by heating with these warm-air blow-out nozzle 58 and IR heater 60, and a thin layer of the treatment liquid is formed on the recording surface. Where the treatment liquid is formed into such a thin layer, the dots of ink deposited in the image formation unit 14 come into contact with the recording surface of the recording medium 22 and a necessary dot diameter is obtained. Moreover, the ink reacts with the components of the treatment liquid formed into the thin layer, coloring material aggregation occurs, and an action fixing the ink to the recording surface of the recording medium 22 is easily obtained. The treatment liquid drum 54 may be controlled to a predetermined temperature (for example, 50° C.).

First to fourth embodiments of the concrete composition of the treatment liquid application device 56 are described below.

### First Embodiment

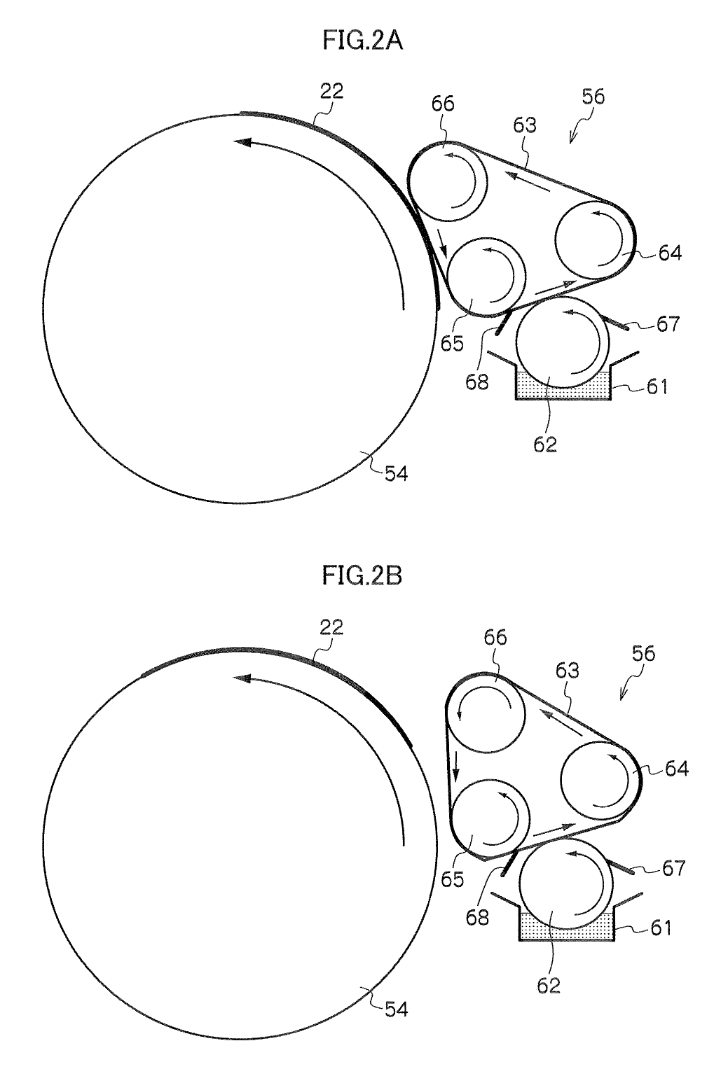

FIGS. 2A and 2B show schematic views of the composition of the treatment liquid application device 56 according to the first embodiment. As shown in FIGS. 2A and 2B, the treatment liquid application device 56 has a treatment liquid fountain 61, a metering roller 62, a belt 63, and rollers 64, 65 and 66, around which the belt 63 is wound.

The treatment liquid fountain 61 holds the treatment liquid, in which a part of the metering roller 62 is immersed. The metering roller 62 can be a rubber roller having a surface rubber layer of EPDM or silicone, or the like, or an anilox roller having a multiplicity of cells regularly arranged in a set number of lines on the circumferential surface of a roller having a ceramic coating or chrome plating, or the like. If an anilox roller is used as the metering roller 62, then it is appropriate to use, for example, a roller having 133 lines or more and 300 lines or less (desirably, 150 lines), a cell depth of 20 μm or more and 75 μm or less (desirably, 60 μm), and a cell volume of 5 cm³/m². The size of the metering roller 62 is desirably similar to or slightly greater than the rollers 64 to 66; for instance, the metering roller 62 has a diameter of 20 mm or more and 100 mm or less (desirably, approximately 50 mm).

The metering roller 62 is disposed in contact with the belt 63 between the rollers 64 and 65. The metering roller 62 is supported rotatably and is coupled to a motor (not shown) to be driven to rotate at a uniform speed. Consequently, the treatment liquid in the treatment liquid fountain 61 is applied to the surface of the metering roller 62, and this treatment liquid is transferred to the surface of the belt 63.

Desirably, the direction of rotation of the metering roller 62 is the opposite of the direction of travel of the belt 63 at the point of contact with the belt 63. By setting the direction of rotation of the metering roller 62 and the direction of travel of the belt 63 to be opposite directions, it is possible to satisfactorily and efficiently transfer the treatment liquid on the surface of the measurement roller 62 to the belt 63 so as to have a good surface state of the applied liquid on the belt 63.

A doctor blade 67 for measuring the amount is arranged so as to abut against the surface of the metering roller 62. The doctor blade 67 is disposed to the upstream side of the point of contact between the metering roller 62 and the belt 63 in terms of the direction of rotation of the metering roller 62, in such a manner that the excess treatment liquid on the surface of the metering roller 62 is scraped off and the amount thereof can be measured out. Thus, it is possible to supply the treatment liquid measured out by the doctor blade 67 to the belt 63.

The belt 63 is formed in an endless fashion, and is wrapped about the three rollers 64, 65 and 66. The material of the belt 63 is desirably a resin such as PET (polyethyleneterephthalate) or polyimide. It is desirable that the surface of the belt 63 is treated with a hydrophilizing treatment by a corona discharge process, or the like, or is covered with a metal such as aluminum by a vapor deposition. It is also desirable that the Young's modulus of the material of the belt 63 is 1000 MPa or greater and more desirably, 2000 MPa or greater. The belt 63 is desirably tensioned about the rollers 64 to 66, and preferably, the tension thereof is 10 to 1000 N/m. Furthermore, as shown in FIG. 2A, the belt 63 is disposed so as to make contact with the recording medium 22 that is conveyed by rotation on the treatment liquid drum 54.

At least one of the three rollers 64, 65 and 66 is a drive roller and the other rollers are idle rollers, and the belt 63 is caused to travel by driving the drive roller to rotate. Although the direction of travel of the belt 63 is not limited in particular, it is desirably opposite to the direction of rotational conveyance of the recording medium 22 at the point of contact with the recording medium 22. This is because if the direction of travel of the belt 63 and the direction of rotational conveyance of the recording medium 22 are the same, then air bubbles may occur due to the release of pressure when the belt 63 and the recording medium 22 separate from each other. Furthermore, the speed of travel of the belt 63 is desirably between 1 time and 1.5 times (both inclusive) the speed of rotational conveyance of the recording medium 22. If the speed of the belt is less than 1 time the speed of the recording medium, then insufficiency in the supply of treatment liquid occurs, whereas if it is more than 1.5 times the speed of the recording medium, then the recording medium 22 becomes liable to be damaged even by contact with the belt 63.

The size of the rollers 64, 65 and 66 is set in accordance with the size of the treatment liquid drum 54, and for example, if the treatment liquid drum 54 has a diameter of 450 mm and a width of 800 mm, then the diameter of the rollers 64, 65 and 66 is set to 20 mm or more and 100 mm or less (and desirably, 40 mm). Desirably, the rollers 64, 65 and 66 have a smaller diameter in order to reduce the dimensions of the apparatus, provided that they have a rigidity in a range capable of withstanding the tension of the belt 63. Furthermore, for the belt 63 it is suitable to use a belt having a thickness of 50 μm or more and 300 μm or less, for example.

Of the three rollers 64, 65 and 66, the two rollers 64 and 65 on the treatment liquid fountain 61 side have fixed positions and the other roller 66 can be moved by a withdrawal mechanism (not shown). More specifically, the roller 66 is moved between an application position indicated in FIG. 2A and a withdrawn position indicated in FIG. 2B. In the application position indicated in FIG. 2A, the belt 63 between the rollers 65 and 66 makes contact with the treatment liquid drum 54 (in practice, the recording medium 22), and in the withdrawn position indicated in FIG. 2B, the belt 63 between the rollers 65 and 66 is separated from the treatment liquid drum 54. Although the mechanism for withdrawing the roller 66 is not limited in particular, it is constituted, for example, of a mechanical device such as a cam mechanism coupled to the rotation of the treatment liquid drum 54, or a cylinder. With regard to the path of travel of the roller 66, in order to keep the tension of the belt 63 unchanged, the roller 66 should be moved in such a manner that the sum of the distance between the rollers 64 and 66 and the distance between the rollers 65 and 66 is uniform at all times.

A doctor blade 68 for scraping treatment liquid is arranged so as to abut against the surface of the belt 63. The doctor blade 68 is disposed to the upstream side of the point of contact between the belt 63 and the metering roller 62 in terms of the direction of travel of the belt 63, and is able to scrape off the treatment liquid on the surface of the belt 63. Thus, since the belt 63 with the treatment liquid having been scraped away therefrom makes contact with the metering roller 62, it is possible to control accurately the amount of treatment liquid conveyed on the belt 63. A mode which does not use the doctor blade 68 is also possible.

In the treatment liquid application device 56 of the above-described configuration, the roller 66 is moved by the withdrawal mechanism in accordance with the position of the recording medium 22. For example, as shown in FIG. 2A, when the recording medium 22 passes the position of the treatment liquid application device 56, the roller 66 is disposed in the application position. Thereby, the recording medium 22 makes contact with the belt 63 between the rollers 65 and 66, and hence it is possible to transfer and apply the treatment liquid on the belt 63, to the recording medium 22.

Furthermore, as shown in FIG. 2B, after the recording medium 22 has passed the position of the treatment liquid application device 56, the roller 66 is moved to the withdrawn position. Thereby, since the belt 63 between the rollers 65 and 66 is separated from the treatment liquid drum 54, it is possible to prevent the adherence of the treatment liquid to the surface of the treatment liquid drum 54. It is preferable that the roller 66 is withdrawn at the moment that the hook-shaped holding device which holds the leading edge of the recording medium 22 passes, so that it is possible to prevent the adherence of the treatment liquid to the holding device. Moreover, by withdrawing the belt 63 from the treatment liquid drum 54 by withdrawing the roller 66, the liquid surface of the treatment liquid fountain 61 is more stable in comparison with a mechanism in which the whole of the application device 56 is withdrawn, and therefore application can be performed with a more satisfactory surface condition of the liquid.

According to the treatment liquid application device 56 of the present embodiment, the treatment liquid inside the treatment liquid fountain 61 is measured out by the metering roller 62 and the doctor blade 67 and is supplied to the surface of the belt 63. This supplied treatment liquid is then transferred and applied through the belt 63 to the surface of the recording medium 22 which is rotationally conveyed by the treatment liquid drum 54.

When the treatment liquid is applied to the recording medium 22 which is rotationally conveyed by the treatment liquid drum 54, there is a problem in that it is difficult to uniformly apply the treatment liquid. Furthermore, if the treatment liquid is applied by means of a roller as in the related art, then not only does the applied treatment liquid become uneven, but there is also a risk that the recording medium 22 will be damaged by the pressure of the roller.

In response to this, in the present embodiment, the treatment liquid is applied through the belt 63 to the recording medium 22 rotationally conveyed by the treatment liquid drum 54, and therefore the recording medium 22 is pressed substantially uniformly against the belt 63 and the treatment liquid is uniformly applied, and furthermore, it is also possible to prevent damage to the recording medium 22. Moreover, by setting the belt 63 to rotate in the direction opposite to the direction of rotational conveyance of the recording medium 22 at the point of contact of the belt 63 with the recording medium 22, then the occurrence of air bubbles due to the release of pressure upon separation between the belt 63 and the recording medium 22 is prevented, and application can be carried out with a more satisfactory surface condition of the liquid.

### Second Embodiment

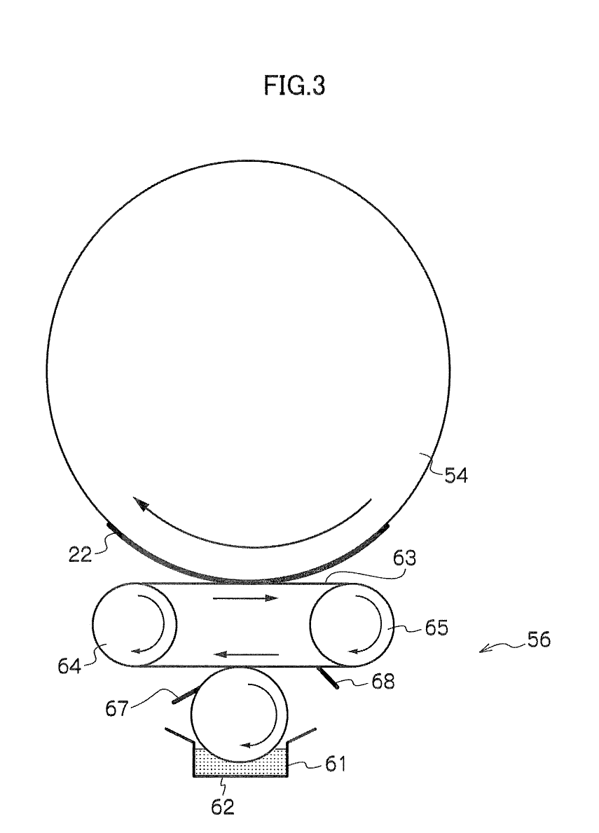

FIG. 3 shows a schematic view of the composition of the treatment liquid application device 56 according to a second embodiment. As shown in FIG. 3, the treatment liquid application device 56 according to the second embodiment is disposed on the lower side of the treatment liquid drum 54, and the belt 63 is wound between two rollers 64 and 65. The belt 63 on the upper side between the rollers 64 and 65 makes contact with the treatment liquid drum 54 (in practice, the recording medium 22), and the belt 63 on the lower side between the rollers 64 and 65 is disposed so as to contact the metering roller 62. The remainder of the composition is similar to the first embodiment, and the same or similar members as the first embodiment are denoted with the same reference numerals and further description thereof is omitted here.

Similarly to the first embodiment, in the second embodiment composed as described above, since the treatment liquid is applied to the recording medium 22 through the belt 63, then it is possible to uniformly apply the treatment liquid to the recording medium 22, as well as being able to prevent damage to the recording medium 22.

In the second embodiment described above, it is possible to provide a withdrawal mechanism which withdraws the whole of the treatment liquid application device 56 in the downward direction. By this means, it is possible to apply the treatment liquid only to the surface of the recording medium 22, and it is possible to prevent application to the surface of the treatment liquid drum 54 or the holding device of the recording medium 22.

The number of rollers about which the belt 63 is wrapped is not limited to the three rollers in the first embodiment or the two rollers in the second embodiment, and may be four or more rollers.

### Third Embodiment

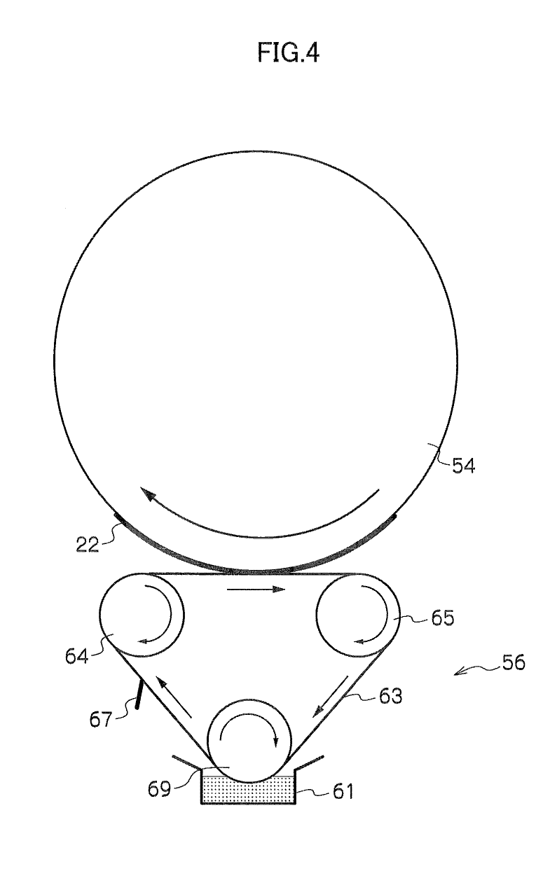

FIG. 4 shows a schematic view of the composition of the treatment liquid application device 56 according to a third embodiment. As shown in FIG. 4, the treatment liquid application device 56 according to the third embodiment is disposed on the lower side of the treatment liquid drum 54, and the belt 63 is wound about three rollers 64, 65 and 69. A portion of the roller 69 is immersed in the treatment liquid held in the treatment liquid fountain 61, the belt 63 is immersed in the treatment liquid at the position of the roller 69, and the treatment liquid is thereby supplied to the surface of the belt 63. The belt 63 is an embossed belt having a regular fine pattern of recesses and projections on the surface thereof, and the doctor blade 67 for measuring the amount abuts against the belt 63 to thereby measure the amount of the applied treatment liquid. For the embossed belt, it is suitable to use a belt having, for example, a thickness of 100 μm or more and 300 μm or less, a number of lines of 133 lines or more and 300 lines or less (desirably, 150 lines), a cell depth of 20 μm or more and 75 μm or less (desirably, 60 μm), and a cell volume of 5 cm³/m² or more and 50 cm³/m² or less.

Similarly to the first embodiment, in the third embodiment which is composed as described above, since the treatment liquid is applied to the recording medium 22 through the belt 63, then it is possible to uniformly apply the treatment liquid to the recording medium 22. In particular, in the third embodiment, the belt 63 is immersed directly in the treatment liquid, and hence there is no need to provide a separate device, such as a metering roller, or the like, and a simple composition is obtained.

In the case of the third embodiment described above as well, it is possible to provide a withdrawal mechanism which withdraws the whole of the treatment liquid application device 56 in the downward direction. By this means, it is possible to apply the treatment liquid only to the surface of the recording medium 22, and it is possible to prevent application to the surface of the treatment liquid drum 54 or the holding device of the recording medium 22.

Furthermore, similarly to the first embodiment, it is also possible to provide a mechanism whereby the belt 63 is withdrawn from the treatment liquid drum 54 by withdrawing at least one of the rollers 64 and 65. By this means, the liquid surface in the treatment liquid fountain 61 is stable and application can be carried out with a more satisfactory surface condition of the liquid.

### Fourth Embodiment

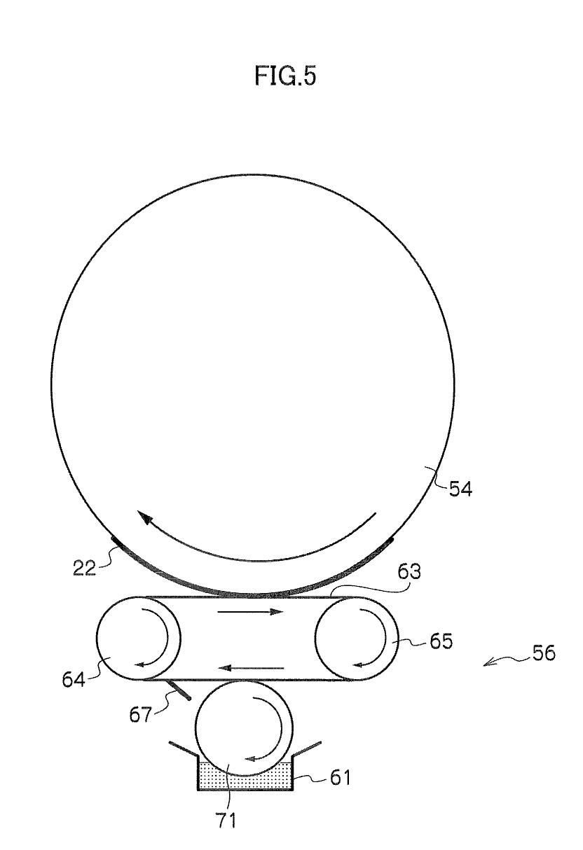

FIG. 5 shows a schematic view of the composition of the treatment liquid application device 56 according to a fourth embodiment. As shown in FIG. 5, the treatment liquid application device 56 according to the fourth embodiment is disposed on the lower side of the treatment liquid drum 54, and the belt 63 is wound about two rollers 64 and 65. The belt 63 is an embossed belt having a regular fine pattern of recesses and projections on the surface thereof, and the doctor blade 67 for measuring the amount abuts against the belt 63 to thereby measure the amount of the applied treatment liquid. Similarly to the third embodiment, for the embossed belt, it is suitable to use a belt having, for example, a thickness of 100 μm or more and 300 μm or less, a number of lines of 133 lines or more and 300 lines or less (desirably, 150 lines), a cell depth of 20 μm or more and 75 μm or less (desirably, 60 μm), and a cell volume of 5 cm³/m² or more and 50 cm³/m² or less.

A roller 71 for transferring the treatment liquid, such as a gravure roller, is arranged on the belt 63 on the lower side between the rollers 64 and 65. The roller 71 is partially immersed in the treatment liquid held in the treatment liquid fountain 61, and is driven to rotate by a motor (not shown). The direction of rotation of the roller 71 is set to be opposite to the direction of travel of the belt 63 with respect to the point of contact with the belt 63.

In the fourth embodiment of the above-described configuration, a greater amount of treatment liquid than the desired application amount is supplied from the roller 71 to the belt 63. Thereupon, the amount of the applied treatment liquid on the belt 63 is measured by the doctor blade 67, and the treatment liquid is then transferred and applied to the recording medium 22. Consequently, in the fourth embodiment, similarly to the first embodiment, since the treatment liquid is applied to the recording medium 22 through the belt 63, then it is possible to uniformly apply the treatment liquid to the recording medium 22. Furthermore, since the treatment liquid on the belt 63 is measured out by the doctor blade 67 before making contact with the recording medium 22, it is possible to apply the treatment liquid of an accurate amount to the recording medium 22.

### <Image Formation Unit>

As shown in FIG. 1, the image formation unit 14 is composed of an image formation drum 70 and ink heads 72C, 72M, 72Y, 72K that are proximally disposed in a position facing the outer peripheral surface of the image formation drum 70. The ink heads 72C, 72M, 72Y, 72K correspond to inks of four colors: cyan (C), magenta (M), yellow (Y), and black (K) and are disposed in the order of description from the upstream side in the rotation direction of the image formation drum 70.

The image formation drum 70 is a drum that holds the recording medium 22 on the outer peripheral surface thereof and rotationally conveys the recording medium. The image formation drum 70 is driven to rotate. The image formation drum 70 is provided on the outer peripheral surface thereof with a hook-shaped holding device 73, and the leading end of the recording medium 22 is held by the holding device 73. In a state in which the leading end of the recording medium 22 is held by the holding device 73, the image formation drum 70 is rotated to convey rotationally the recording medium. In this case, the recording medium 22 is conveyed so that the recording surface thereof faces outside. Inks are applied to the recording surface by the ink heads 72C, 72M, 72Y, 72K.

The ink heads 72C, 72M, 72Y, 72K are recording heads (inkjet heads) of an inkjet system of a full line type that have a length corresponding to the maximum width of the image formation region in the recording medium 22. A nozzle row is formed on the ink ejection surface of the ink head. The nozzle row has a plurality of nozzles arranged therein for discharging ink over the entire width of the image recording region. Each ink head 72C, 72M, 72Y, 72K is fixedly disposed so as to extend in the direction perpendicular to the conveyance direction (rotation direction of the image formation drum 70) of the recording medium 22.

The ink heads 72C, 72M, 72Y, 72K are respectively provided with ink cassettes containing colored inks of corresponding colors. Each of the colored inks contains at least pigment particles (A), dispersant polymer (B) that coats the pigment, and self-dispersible polymer particles (C). Droplets of the colored inks are ejected from the ink heads 72C, 72M, 72Y, 72K toward the recording surface of the recording medium 22 held on the outer peripheral surface of the image formation drum 70. As a result, the ink comes into contact with the treatment liquid that has been heretofore applied on the recording surface by the treatment liquid application unit 12, the coloring material (pigment) dispersed in the ink is aggregated, and a coloring material aggregate is formed. Therefore, the coloring material flow on the recording medium 22 is prevented and an image is formed on the recording surface of the recording medium 22. In this case, because the image formation drum 70 of the image formation unit 14 is structurally separated from the treatment liquid drum 54 of the treatment liquid application unit 12, the treatment liquid does not adhere to the ink heads 72C, 72M, 72Y, 72K, and the number of factors preventing the ejection of ink can be reduced.

The following reaction can be considered as the reaction of ink and treatment liquid. For example, by using a mechanism of breaking the pigment dispersion and causing aggregation by introducing an acid into the treatment liquid and decreasing pH, it is possible to avoid oozing of the coloring agent, color mixing among inks of different colors, and deposition interference caused by merging of ink droplets during landing.

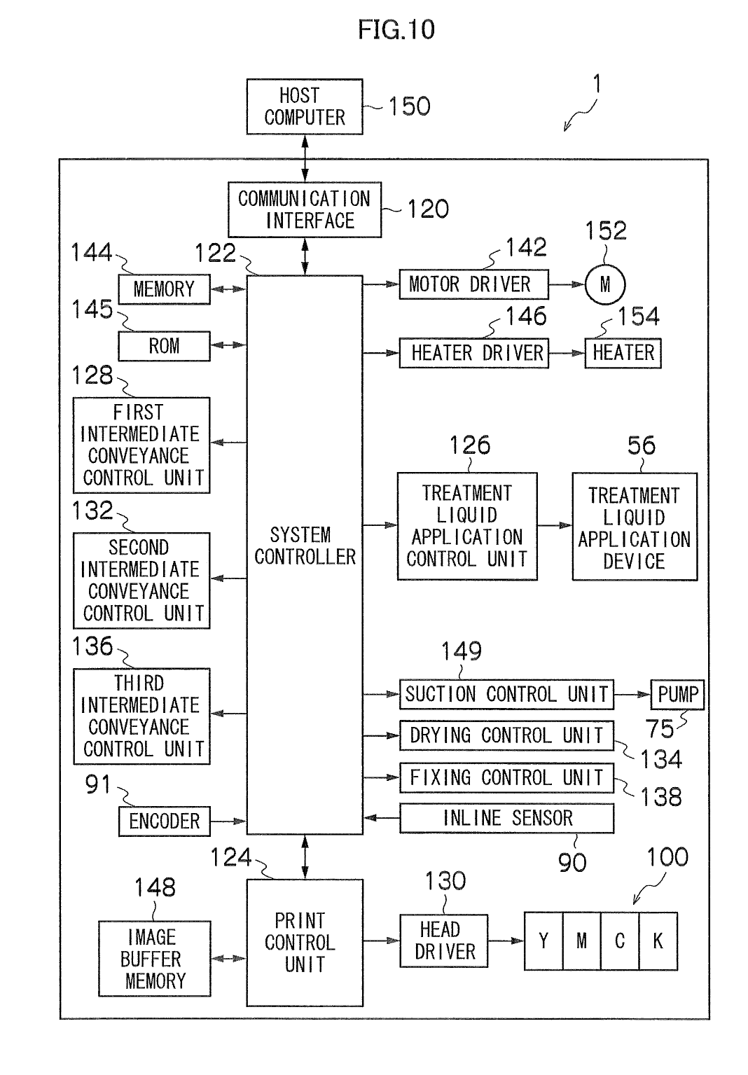

The ejection timing of the ink heads 72C, 72M, 72Y, 72K is synchronized by an encoder 91 (see FIG. 10) that is disposed in the image formation drum 70 and detects the rotation speed. As a result, landing positions can be determined with high accuracy. Further, it is also possible to learn in advance the speed fluctuations caused, e.g., by oscillations of the image formation drum 70 and correct the ejection timing obtained with the encoder 91, exclude the effect of oscillations of the image formation drum 70, accuracy of the rotation shafts, and speed of the outer peripheral surface of the image formation drum 70, and reduce the unevenness of deposition.

Further, maintenance operations such as cleaning of the nozzle surface of the ink heads 72C, 72M, 72Y, 72K and ejection of thickened ink may be performed after the head units have been withdrawn from the image formation drum 70.

In the present example, a CMYK standard color (four color) configuration is described, but combinations of ink colors and numbers of colors are not limited to that of the present embodiment, and if necessary, light inks, dark inks, and special color inks may be added. For example, a configuration is possible in which an ink head is added that ejects a light ink such as light cyan and light magenta. The arrangement order of color heads is also not limited.

### <Drying Unit>

The drying unit 16 dries water included in the solvent separated by the coloring material aggregation action. The drying unit 16 includes a drying drum 76 and a first IR heater 78, a warm-air blow-out nozzle 80, and a second IR heater 82 disposed in positions facing the outer peripheral surface of the drying drum 76. The first IR heater 78 is provided upstream of the warm-air blow-out nozzle 80 in the rotation direction (counterclockwise direction in FIG. 1) of the drying drum 76, and the second IR heater 82 is provided downstream of the warm-air blow-out nozzle 80.

The drying drum 76 is a drum that holds the recording medium 22 on the outer peripheral surface thereof and rotationally conveys the recording medium. The drying drum 76 is driven to rotate. Further, the drying drum 76 is provided on the outer peripheral surface thereof with hook-shaped holding device, by which the leading end of the recording medium 22 is held. In a state in which the leading end of the recording medium 22 is held by the holding device, the drying drum 76 is rotated to convey rotationally the recording medium. In this case, the recording medium 22 is conveyed so that the recording surface thereof faces outside. The drying treatment is carried out by the first IR heater 78, warm-air blow-out nozzle 80, and second IR heater 82 with respect to the recording surface of the recording medium.

The warm-air blow-out nozzle 80 is configured to blow hot air at a high temperature (for example, 50° C. to 70° C.) at a constant blowing rate (for example, 12 m³/min) toward the recording medium 22, and the first IR heater 78 and second IR heater 82 are controlled to respective high temperature (for example, 180° C.). Water included in the ink solvent on the recording surface of the recording medium 22 held by the drying drum 76 is evaporated by heating with these first IR heater 78, warm-air blow-out nozzle 80, and second IR heater 82 and drying treatment is performed. In this case, because the drying drum 76 of the drying unit 16 is structurally separated from the image formation drum 70 of the image formation unit 14, the number of ink non-ejection events caused by drying of the head meniscus portion by thermal drying can be reduced in the ink heads 72C, 72M, 72Y, 72K. Further, there is a degree of freedom in setting the temperature of the drying unit 16, and the optimum drying temperature can be set.

It is desirable to control the drying temperature in such a manner that the relationship Td<Tp is satisfied, where Td is the arrival temperature of the image surface at the drying step and Tp is the softening point of the self-dispersible polymer particles in the ink. By controlling the drying temperature to Td<Tp, it is possible to prevent contraction of the dot diameter, and it is also possible to prevent the occurrence of image folding (a state where the image bends in a folded shape), as well as being able to prevent decline in image adhesiveness, wearability and image luster due to the folding of the image. Here, the softening temperature Tp of the self-dispersible polymer particles is desirably 30° C. or above and 70° C. or below. This is because if Tp is lower than 30° C., then an offset occurs due to insufficient drying, and if Tp exceeds 70° C., then the film properties are insufficient in the case of high-speed recording.

The evaporated moisture may be released to the outside of the apparatus with a release device (not shown in the drawings). Further, the recovered air may be cooled with a 5 cooler (radiator) or the like and recovered as a liquid.

The outer peripheral surface of the aforementioned drying drum 76 may be controlled to a predetermined temperature (for example, not higher than 60° C.).

The drying drum 76 may be provided with suction holes on the outer peripheral surface thereof and connected to a suction device which performs suction from the suction holes. As a result, the recording medium 22 can be tightly held on the circumferential surface of the drying drum 76.

### <Fixing Unit>

The fixing unit 18 includes a fixing drum 84, a first fixing roller 86, a second fixing roller 88, and an inline sensor 90. The first fixing roller 86, second fixing roller 88, and inline sensor 90 are arranged in positions opposite the circumferential surface of the fixing drum 84 in the order of description from the upstream side in the rotation direction of the fixing drum 84.

The fixing drum 84 holds the recording medium 22 on the outer peripheral surface thereof, and rotationally conveys the recording medium. The fixing drum 84 is driven to rotate. The fixing drum 84 has a hook-shaped holding device, and the leading end of the recording medium 22 can be held by this holding device. The recording medium 22 is rotated and conveyed by rotating the fixing drum 84 in a state in which the leading end of the recording medium is held by the holding device. In this case, the recording medium 22 is conveyed so that the recording surface thereof faces outside, and the fixing treatment by the first fixing roller 86 and second fixing roller 88 and the inspection by the inline sensor 90 are performed with respect to the recording surface.

The first fixing roller 86 and second fixing roller 88 are roller members which heat and press the dried ink to melt and set the self-dispersible polymer particles in the dried ink so that the dried ink forms a film, and they are configured to apply pressure and heat to the recording medium 22. More specifically, the first fixing roller 86 and second fixing roller 88 are arranged so as to be pressed against the fixing drum 84, and a nip roller is configured between them and the fixing drum 84. Thereby, the recording medium 22 is squeezed between the first fixing roller 86 and the fixing drum 84 and between the second fixing roller 88 and the fixing drum 84, nipped under a predetermined nip pressure (for example, 0.15 MPa), and subjected to fixing treatment.

It is desirable that an elastic layer is formed on the surface of the fixing drum 84 or the surfaces of the first fixing roller 86 and the second fixing roller 88 to obtain a configuration providing a uniform nip width with respect to the recording medium 22. For example, each of the surface of the first fixing roller 86 and the surface of the second fixing roller 88 has a two-layer composition, in which the first layer on the outside is composed of a member having separating properties, and the second layer (inside layer) is composed of an elastic rubber member. By forming the first layer of a material having separating properties, the roller becomes less liable to soiling and it is possible to reduce the cleaning load of the roller. Furthermore, desirably, the second layer uses an elastic rubber member having a rubber hardness of 50 degrees or less. By forming the second layer of an elastic rubber material having a hardness of 50 degrees or less, it is possible to gain time during which the recording medium 22 is nipped, which is beneficial in respect of film formation during high-speed recording. Furthermore, by setting the second layer to have a hardness of 50 degrees of less, it becomes possible to reduce the pressure when making contact with the recording medium 22, and it is possible to improve the lifespan of the roller. On the other hand, it is desirable that the first fixing roller 86 and the second fixing roller 88 have a roller surface hardness equal to or lower than 70 degrees. By lowering the surface hardness of the roller, the ability of the roller to follow the recesses and projections in the image (in a uniform time period) is improved, which is beneficial in respect of film formation in the case of high-speed recording.

Further, the first fixing roller 86 and the second fixing roller 88 are configured by heating rollers in which a halogen lamp is incorporated in a metal pipe, for example made of aluminum, having good thermal conductivity and the rollers are controlled to a predetermined temperature (for example 60° C. to 80° C.). If the arrival temperature of the image surface is taken as Tf, then desirably this temperature Tf is set so as satisfy the relationship Tp<Tf with respect to the softening point Tp of the self-dispersible polymer particles in the ink.

With the first fixing roller 86 and second fixing roller 88 of the above-described configuration, the recording medium 22 is heated and pressed so that thermal energy not lower than a Tg temperature (glass transition temperature) of the latex contained in the ink is applied and the latex particles are melted. Thus, fixing is performed by squeezing the ink into the uneven surface of the recording medium 22, the unevenness of the image surface is thereby leveled out, and gloss is obtained.

In the above-described embodiment, heating and pressure application are used in combination, but only one of them may be performed. Further, depending on the thickness of image layer and Tg characteristic of latex particles, the first fixing roller 86 and second fixing roller 88 may have a configuration provided with a plurality of steps. Furthermore, the surface of the fixing drum 84 may be controlled to a predetermined temperature (for example 60° C.).

On the other hand, the inline sensor 90 is a measuring device which measures the check pattern, moisture amount, surface temperature, gloss, and the like of the image fixed to the recording medium 22. A CCD sensor or the like can be used for the inline sensor 90.

With the fixing unit 18 of the above-described configuration, the latex particles located within the thin image layer formed in the drying unit 16 are melted by pressure application and heating by the first fixing roller 86 and second fixing roller 88. Therefore, the latex particles can be reliably fixed to the recording medium 22. In addition, with the fixing unit 18, the fixing drum 84 is structurally separated from other drums. Therefore, the temperature of the fixing unit 18 can be freely set separately from the image formation unit 14 and drying unit 16.

Further, the above-described fixing drum 84 may be provided with suction holes on the outer peripheral surface thereof and connected to a suction device which performs suction from the suction holes. As a result, the recording medium 22 can be tightly held on the circumferential surface of the fixing drum 84.

### <Discharge Unit>

As shown in FIG. 1, the discharge unit 20 is provided after the fixing unit 18. The discharge unit 20 includes a discharge tray 92, and a transfer drum 94, a conveying belt 96, and a tension roller 98 are provided between the discharge tray 92 and the fixing drum 84 of the fixing unit 18 so as to face the discharge tray and the fixing drum. The recording medium 22 is fed by the transfer drum 94 onto the conveying belt 96 and discharged into the discharge tray 92.

### <Intermediate Conveyance Unit>

The structure of the first intermediate conveyance unit 24 will be described below. A second intermediate conveyance unit 26 and a third intermediate conveyance unit 28 are configured identically to the first intermediate conveyance unit 24 and the explanation thereof will be omitted.

The first intermediate conveyance unit 24 has an intermediate conveyance body 30. The intermediate conveyance body 30 is a drum for receiving the recording medium 22 from a drum of a previous stage, rotationally conveying the recording medium, and transferring it to a drum of the subsequent stage, and the intermediate conveyance body 30 is rotationally mounted. The intermediate conveyance body 30 is rotated by a motor (not shown).

Hook-shaped holding devices are provided with a 90° spacing on the outer peripheral surface of the intermediate conveyance body 30. The holding device rotates, while describing a circular path, and the leading end of the recording medium 22 is held by the action of the holding device. Therefore, the recording medium 22 can be rotationally conveyed by rotating the intermediate conveyance body 30 in a state in which the leading end of the recording medium 22 is held by the holding device. It is desirable that the surface of the intermediate conveyance body 30 is provided with a plurality of blower ports to blow air so that the recording medium is conveyed while the recording surface of the recording medium is not in contact with the surface of the intermediate conveyance body 30.

The recording medium 22 conveyed by the first intermediate conveyance unit 24 is transferred to a drum of the subsequent stage (that is, the image formation drum 70). In this case, the transfer of the recording medium 22 is performed by synchronizing the holding device 34 of the intermediate conveyance unit 24 and the holding device 73 of the image formation unit 14. The transferred recording medium 22 is held by the image formation drum 70 and rotationally conveyed.

### <Structure of Ink Heads>

The structure of ink heads will be described below. Because ink heads 72C, 72M, 72Y, 72K have a common structure, an ink head representing them will be denoted below with a reference symbol 100.

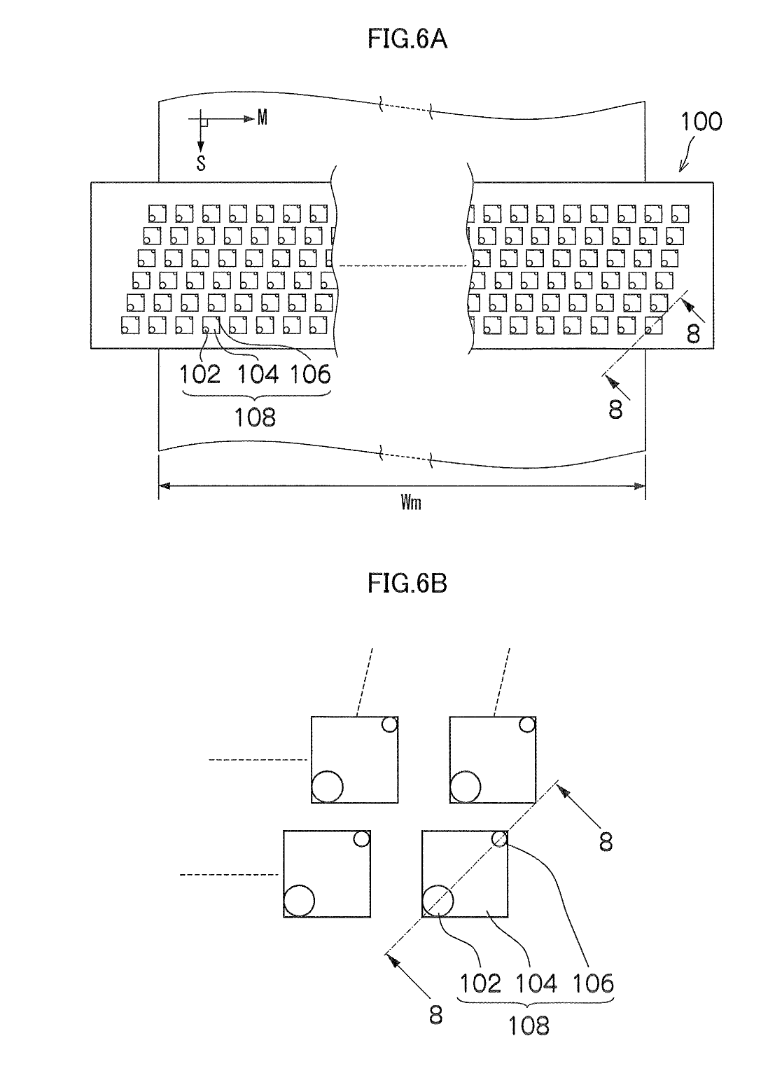

FIG. 6A is a planar perspective view illustrating a structure of the ink head 100. FIG. 6B is an enlarged view of part thereof. A nozzle pitch density in the ink head 100 has to be increased in order to increase the pitch density of dots printed on the recording medium 22. As shown in FIGS. 6A and 6B, the ink head 100 of the present example has a structure in which a plurality of ink chamber units (liquid droplet ejection elements serving as recording element units) 108, each including a nozzle 102 serving as an ink ejection port and a pressure chamber 104 corresponding to the nozzle 102, are arranged in a zigzag manner as a matrix (two-dimensional configuration). As a result, it is possible to increase substantially the density of nozzle spacing (projected nozzle pitch) that is projected to ensure alignment along the longitudinal direction of the head (direction perpendicular to the conveyance direction of the recording medium 22).

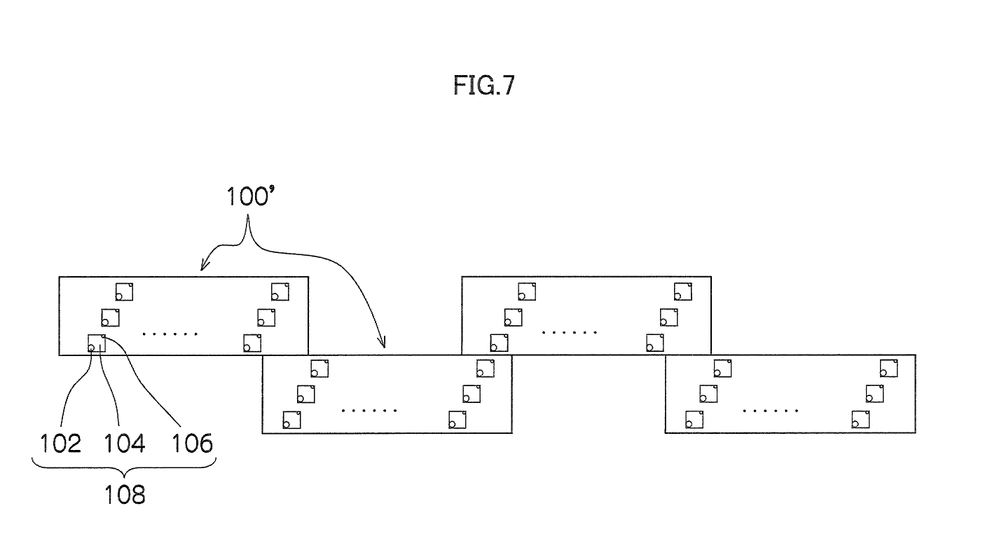

A mode of configuring at least one nozzle column along a length corresponding to the entire width of the image formation region of the recording medium 22 in the direction (arrow M in FIGS. 6A and 6B) that is almost perpendicular to the conveyance direction (arrow S in FIGS. 6A and 6B) of the recording medium 22 is not limited to the example shown in the drawing. For example, instead of the configuration shown in FIG. 6A, a line head that as a whole has a nozzle row of a length corresponding to the entire width of the image formation region of the recording medium 22 may be configured by arranging in a zigzag manner short head modules 100′ in which a plurality of nozzles 102 are arranged two-dimensionally and enlarging the length by joining the modules together as shown in FIG. 7.

The pressure chamber 104 provided correspondingly to each nozzle 102 has an almost square shape in the plan view thereof (see FIGS. 6A and 6B), an outflow port to the nozzle 102 is provided in one of the two corners on a diagonal of the pressure chamber, and an inflow port (supply port) 106 of the supplied ink is provided in the other corner on the diagonal. The shape of the pressure chamber 104 is not limited to that of the present example, and a variety of planar shapes, for example, a polygon such as a rectangle (rhomb, rectangle, etc.), a pentagon and a heptagon, a circle, and an ellipse can be employed.

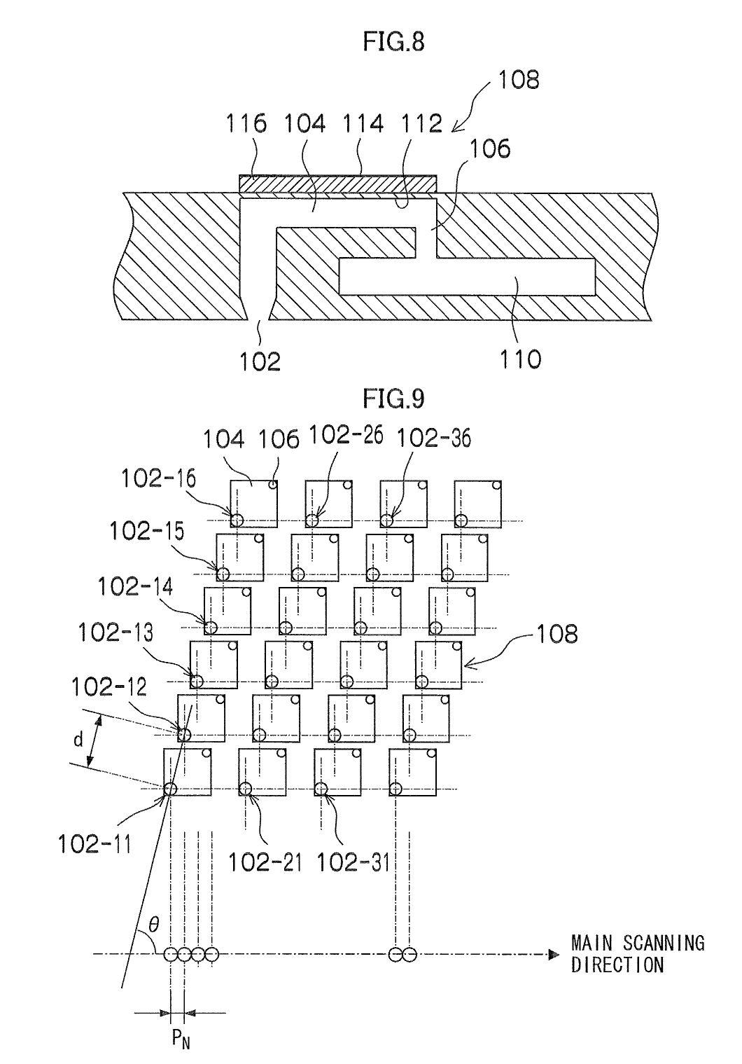

FIG. 8 is a cross-sectional view (cross-sectional view along line 8-8 in FIGS. 6A and 6B) illustrating a three-dimensional configuration of a droplet ejection element (ink chamber unit corresponding to one nozzle 102) of one channel that serves as a recording element unit in the ink head 100.

As shown in FIG. 8, each pressure chamber 104 communicates with a common flow channel 110 via the supply port 106. The common flow channel 110 communicates with an ink tank (not shown in the drawing) that serves as an ink supply source, and the ink supplied from the ink tank is supplied into each pressure chamber 104 via the common flow channel 110.

An actuator 116 having an individual electrode 114 is joined to a pressure application plate (oscillation plate also used as a common electrode) 112 that configures part of the surface (top surface in FIG. 8) of the pressure chamber 104. Where a drive voltage is applied between the individual electrode 114 and the common electrode, the actuator 116 is deformed, the volume of the pressure chamfer 104 changes, and the ink is ejected from the nozzle 102 by the variation in pressure that follows the variation in volume. A piezoelectric element using a piezoelectric material such as lead titanate zirconate or barium titanate can be advantageously used in the actuator 116. When the displacement of the actuator 116 returns to the original state after the ink has been ejected, the pressure chamber 104 is refilled with new ink from the common flow channel 110 via the supply port 106.

An ink droplet can be ejected from the nozzle 102 by controlling the drive of the actuator 116 correspondingly to each nozzle 102 according to dot data generated by a digital half toning processing from the input image. By controlling the ink ejection timing of each nozzle 102 according to the conveyance speed on the recording medium 22, while conveying the recording medium with a constant speed in the sub-scanning direction, it is possible to record the described image on the recording medium 22.

A high-density nozzle head of the present example is realized by arranging a large number of ink chamber units 108 having the above-described configuration in a grid-like manner with a constant arrangement pattern along a row direction coinciding with the main scanning direction and an oblique column direction that is inclined at a certain angle θ, rather than perpendicular, to the main scanning direction, as shown in FIG. 9.

Thus, with a structure in which a plurality of ink chamber units 108 are arranged with a constant pitch, d, along a direction inclined at a certain angle θ to the main scanning direction, a pitch, P, of nozzles projected (front projection) to be aligned in the main scanning direction will be d×cos θ, and with respect to the main scanning direction, the configuration can be handled as equivalent to that in which the nozzles 102 are arranged linearly with a constant pitch P. With such a configuration, it is possible to realize a substantial increase in density of nozzle columns that are projected so as to be aligned in the main scanning direction.

When the nozzles are driven with a full line head that has a nozzle column of a length corresponding to the entire printable width, the drive can be performed by: (1) simultaneously driving all the nozzles, (2) successively driving the nozzles from one side to the other, and (3) diving the nozzles into blocks and successively driving in each block from one side to the other. A nozzle drive such that one line (a line produced by dots of one column or a line composed of dots of a plurality of columns) is printed in the direction perpendicular to the conveyance direction of the recording medium 22 is defined as main scanning.

In particular, when the nozzles 102 arranged in a matrix such as shown in FIG. 9 are driven, the main scanning of the above-described type (3) is preferred. Thus, nozzles 102-11, 102-12, 102-13, 102-14, 102-15, and 102-16 are taken as one block (also, nozzles 102-21, . . . , 102-26 are taken as one block, nozzles 102-31, . . . , 102-36 are taken as one block) and the nozzles 102-11, 102-12, . . . , 102-16 are successively driven in accordance with the conveyance speed of the recording medium 22, thereby printing one line in the direction perpendicular to the conveyance diction of the recording medium 22.

On the other hand, a process in which printing of one line (a line produced by dots of one column or a line composed of dots of a plurality of columns) formed in the aforementioned main scanning area is repeated by moving the above-described full line head and the recording medium 22 relative to each other is defined as sub-scanning.

Accordingly, the direction indicated by one line (or a longitudinal direction of a band-like region) recorded in the above-described main scanning is called a main scanning direction, whereas the direction in which the aforementioned sub-scanning is performed called a sub-scanning direction. Thus, in the present embodiment, the conveyance direction of the recording medium 22 will be called a sub-scanning direction, and the direction perpendicular thereto will be called a main scanning direction. The arrangement structure of the nozzles in the implementation of the present embodiment is not limited to that shown by way of an example in the drawings.

Further, in the present embodiment, a system is employed in which ink droplets are ejected by the deformation of an actuator 116 such as a piezoelectric element, but a system for ejecting the ink in the implementation of the present embodiment is not particularly limited, and a variety of systems can be employed instead of the piezo jet system. An example of another suitable system is a thermal jet system in which the ink is heated by a heat-generating body such as a heater, gas bubbles are generated, and the ink droplets are ejected by the pressure of gas bubbles.

### <Explanation of Control System>

FIG. 10 is a block diagram of the main portion of a system configuration of the inkjet recording apparatus 1. The inkjet recording apparatus 1 include a communication interface 120, a system controller 122, a printing control unit 124, a treatment liquid application control unit 126, a first intermediate conveyance control unit 128, a head driver 130, a second intermediate conveyance control unit 132, a drying control unit 134, a third intermediate conveyance control unit 136, a fixing control unit 138, an inline sensor 90, an encoder 91, a motor driver 142, a memory 144, a heater driver 146, an image buffer memory 148, and a suction control unit 149.

The communication interface 120 is an interface unit that receives image data sent from a host computer 150. A serial interface such as USB (Universal Serial Bus), IEEE 1394, Ethernet, and a wireless network, or a parallel interface such as Centronix can be applied as the communication interface 120. A buffer memory (not shown in the drawing) may be installed in the part of the interface to increase the communication speed. The image data sent from the host computer 150 are introduced into the inkjet recording apparatus 1 via the communication interface 120 and temporarily stored in the memory 144.

The system controller 122 includes a central processing unit (CPU) and a peripheral circuitry thereof, functions as a control device that controls the entire inkjet recording apparatus 1 according to a predetermined program, and also functions as an operational unit that performs various computations. Thus, the system controller 122 controls various units such as the treatment liquid application control unit 126, first intermediate conveyance control unit 128, head driver 130, second intermediate conveyance control unit 132, drying control unit 134, third intermediate conveyance control unit 136, a fixing control unit 138, motor driver 142, memory 144, heater driver 146, and suction control unit 149, performs communication control with the host computer 150, performs read/write control of the memory 144, and also generates control signals for controlling the motor 152 and heater 154 of the conveyance system.

The memory 144 is a storage device that temporarily stores the images inputted via the communication interface 120 and reads/writes the data via the system controller 122. The memory 144 is not limited to a memory composed of semiconductor elements and may use a magnetic medium such as a hard disk.

Programs that are executed by the CPU of the system controller 122 and various data necessary for performing the control are stored in the ROM 145. The ROM 145 may be a read-only storage device or may be a writable storage deice such as EEPROM. The memory 144 can be also used as a region for temporary storing image data, a program expansion region, and a computational operation region of the CPU.

The motor driver 142 drives the motor 152 according to the indications from the system controller 122. In FIG. 10, a representative example of the motors disposed for all the units in the apparatus is denoted by the reference numeral 152. For example, the motor 152 shown in FIG. 10 includes motors for driving the rotation of the transfer drum 52, treatment liquid drum 54, image formation drum 70, drying drum 76, fixing drum 84, and transfer drum 94 shown in FIG. 1, a drive motor for the pump 75 designed for negative-pressure suction from the suction holes of the image formation drum 70, and motors of reciprocating mechanisms of the head units of ink heads 72C, 72M, 72Y, and 72K.

The heater driver 146 drives the heater 154 according to the indications from the system controller 122. In FIG. 10, a representative example of a plurality of heaters provided in the inkjet recording apparatus 1 is denoted by the reference numeral 154. For example, the heaters 154 shown in FIG. 10 include a preheater (not shown in the drawing) for heating the recording medium 22 in advance to an appropriate temperature in the paper feed unit 10.

The printing control unit 124 has a signal processing function for performing a variety of processing and correction operations for generating signals for print control from the image data within the memory 144 according to control of the system controller 122, and supplies the generated printing data (dot data) to the head driver 130. The required signal processing is implemented in the printing control unit 124, and the ejection amount and ejection timing of ink droplets in the ink head 100 are controlled via the head driver 130 based on the image data. As a result, the desired dot size and dot arrangement are realized.

The printing control unit 124 is provided with an image buffer memory 148, and data such as image data or parameters are temporarily stored in the image buffer memory 148 during image data processing in the printing control unit 124. In FIG. 10, a configuration is shown in which the image buffer memory 148 is installed for the printing control unit 124, but it can be also used in combination with the memory 144. Furthermore, a mode in which the printing control unit 124 and the system controller 122 are integrated and configured by one processor is also possible.

The flow of processing from image input to printing output is described schematically below. The data of the image that is to be printed are inputted from the outside via the communication interface 120 and stored in the memory 144. At this stage, the RGB image data are stored, for example, in the memory 144.

In the inkjet recording apparatus 1, in order to form an image with a gradation that seems pseudo-continuous to human eye, it is necessary to perform a conversion to a dot pattern such that reproduces the gradation (shading of image) of the inputted digital image as truly as possible by changing the deposition density or size of fine dots formed by the ink (coloring material). For this purpose, data of the original image (RGB) that have been stored in the memory 144 are sent to the printing control unit 124 via the system controller 122 and converted in the printing control unit 124 into dot data for each ink color by a half-toning processing using a threshold matrix or an error diffusion method.

Thus, the printing control unit 124 performs a processing of converting the inputted RGB image data into dot data of four colors K, C, M and Y. The dot data thus generated in the printing control unit 124 are accumulated in the image buffer memory 148.

The head driver 130 outputs a drive signal for driving the actuator 116 corresponding to each nozzle 102 of the ink head 100 based on the printing data (that is, dot data stored in the image buffer memory 148) provided from the printing control unit 124. A feedback control system serving to maintain constant driving conditions of the heads may be included in the head driver 130.

The drive signal outputted from the head driver 130 is applied to the ink head 100, whereby ink is ejected from the corresponding nozzle 102. An image is formed on the recording medium 22 by controlling the ejection of ink from the ink head 100, while conveying the recording medium 22 with the predetermined speed.

Further, the system controller 122 controls the treatment liquid application control unit 126, first intermediate conveyance control unit 128, second intermediate conveyance control unit 132, drying control unit 134, third intermediate conveyance control unit 136, fixing control unit 138, and suction control unit 149.

The treatment liquid application control unit 126 controls the operation of the treatment liquid application device 56 of the treatment liquid application unit 12 in accordance with the indications from the system controller 122.

The first intermediate conveyance control unit 128 controls the operation of the intermediate conveyance body 30 of the first intermediate conveyance unit 24 in accordance with the indications from the system controller 122. More specifically, the rotation drive of the intermediate conveyance body 30 itself and the rotation of the holding devices provided in the intermediate conveyance body 30 are controlled in the intermediate conveyance body 30. The second intermediate conveyance control unit 132 and the third intermediate conveyance control unit 136 perform the control similarly to the first intermediate conveyance control unit 128.

### <Specific Effects of Inkjet Recording Apparatus>

In the inkjet recording apparatus 1 of the above-described configuration, the treatment liquid application device 56 applies the treatment liquid through the belt 63 to the recording medium 22 which is rotationally conveyed by the treatment liquid drum 54, and therefore it is possible to apply the treatment liquid uniformly to the recording medium 22. Consequently, when ink is deposited onto the recording medium in the image formation unit 14, the ink reacts with the treatment liquid that has been applied in substantially uniform fashion, and therefore it is possible to prevent non-uniformities in the aggregation or precipitation of the ink. Accordingly, it is possible to enhance image quality.

The inkjet recording apparatus and the inkjet recording method in accordance with the present invention are described hereinabove in details; however, the present invention is not limited to the above-described examples and it goes without saying that various modification and changes may be made without departing from the scope of the present invention.

### Recording Medium

There are no particular restrictions on the recording media used in the embodiment of the present invention; however, particularly desirable results can be obtained with coated printing papers, which have a slow rate of permeation of the ink solvent.

Possible examples of support media which can be used appropriately for coated paper are: a base paper manufactured using a Fourdrinier paper machine, cylindrical-wire paper machine, twin-wire paper machine, or the like, from main components of wood pulp or pigment, the pulp being either a chemical pulp such as LBKP or NBKP, a mechanical pulp, such as GP, PGW, RMP, TMP, CTMP, CMP, CGP, or the like, or recovered paper pulp, such as DIP, and the main components being mixed with one or more additive of a sizing agent, fixing agent, yield enhancer, cationization agent, paper strength enhancer, or the like, or a base paper provided with a size press layer or anchor coating layer formed using starch, polyvinyl alcohol, or the like, or an art paper, coated paper, or cast coated paper, or the like, formed by providing a coating layer on top of the size press layer or anchor coating layer.

In the present embodiment, it is possible to use these base papers or coated papers directly without alteration, and it is also possible to use these papers after carrying out a calendering process using a machine calender, TG calender, soft calender, or the like, and thereby controlling the surface smoothness of the paper.

There are no particular restrictions on the weight of the support medium, although generally the weight is approximately 40 g/m² to 300 g/m². The coated paper used in the present embodiment has the coating layer formed on the support medium described above. The coating layer includes a coating composition having a main component of pigment and binder, and at least one layer thereof is formed on the support medium.

For the pigment, it is desirable to use a white pigment. Possible examples of the white pigment are: an inorganic pigment, such as precipitated calcium carbonate, heavy calcium carbonate, magnesium carbonate, kaolin, talc, calcium sulfate, barium sulfate, titanium dioxide, zinc oxide, zinc sulfide, zinc carbonate, satin white, aluminum silicate, diatomaceous earth, calcium silicate, magnesium silicate, synthetic non-crystalline silica, colloidal silica, alumina, colloidal alumina, pseudo-boehmite, aluminum hydroxide, lithopone, zeolite, hydrated halloysite, magnesium hydroxide, or the like; or an organic pigment, such as a styrene-based plastic pigment, an acrylic plastic pigment, polyethylene, microcapsules, urea resin, melamine resin, or the like.

Possible examples of the binder are: a starch derivative, such as oxidized starch, etherified starch, or phosophoric acid esterized starch; a cellulose derivative, such as carboxymethyl cellulose, hydroxyethyl cellulose, or the like; casein, gelatine, soybean protein, polyvinyl alcohol, or derivatives of same; polyvinyl alcohols having various degrees of saponification or silanol-denatured versions of same, or carboxylates, cationized products, of other derivatives of same; polyvinyl pyrrolidone, maleic anhydride resin, a styrene-butadiene copolymer, a methyl methacrylate-butadiene coplymer, or other conjugated diene copolymer latex; an acrylic polymer latex, such as a polymer or copolymer of acrylate ester and methacrylate ester; a vinyl polymer latex, such as such as an ethylene acetate vinyl copolymer; or a functional group-denatured polymer latex based on these various polymers and a monomer containing a functional group such as a carboxy group; an aqueous adhesive of a heat-curable synthetic resin, such as melamine resin, urea resin, or the like; an acrylate ester such as polymethylmethacrylate; methacrylate ester polymer or copolymer resin, such as methacrylate ester; or a synthetic resin-based adhesive, such as polyurethane resin, unsaturated polyester resin, vinyl chloride-vinyl acetate copolymer, polyvinyl butylal, allyd resin, or the like.

The combination ratio of the pigment and binder in the coating layer is 3 to 70 parts by weight, and desirably 5 to 50 parts by weight, of binder with respect to 100 parts by weight of pigment. If the combination ratio of the binder with respect to 100 parts by weight of pigment is less than 3 parts by weight, then the coating of the ink receiving layer by the coating composition will have insufficient strength. On the other hand, if the combination ratio is greater than 70 parts by weight, then the absorption of high-boiling-point solvent is slowed dramatically.

Moreover, it is also possible to combine various additives in appropriate fashion in the coating layer, such as: a dye fixing agent, a pigment dispersant, a viscosity raising agent, a fluidity enhancer, an antifoaming agent, a foam suppressant, a separating agent, a foaming agent, a permeating agent, a coloring dye, a coloring pigment, a fluorescent brightener, an ultraviolet light absorber, an antioxidant, an anticorrosive, an antibacterial agent, a waterproofing agent, a wet paper strength enhancer, a dry paper strength enhancer, or the like.

The application amount of the ink receiving layer varies depending on the required luster, the ink absorbing properties and the type of support medium, or the like, and although no general figure can be stated, it is normally 1 g/M² or greater. Furthermore, the ink receiving layer can also be applied by dividing a certain uniform application amount into two application steps. If application is divided into two steps in this way, then the luster is raised in comparison with a case where the same application amount is applied in one step.

The application of the coating layer can be carried out using one of various types of apparatus, such as a blade coater, roll coater, air knife coater, bar coater, rod blade coater, curtain coater, short dowel coater, size press, or the like, in on-machine or off-machine mode. Furthermore, after application of the coating layer, it is also possible to carry out a smoothing and finishing process on the ink receiving layer by using a calender apparatus, such as a machine calender, a TG calender, a soft calender, or the like. The number of coating layers can be determined appropriately in accordance with requirements.

The coating paper may be an art paper, high-quality coated paper, medium-quality coated paper, high-quality lightweight coated paper, medium-quality lightweight coated paper, or light-coated printing paper; the application amount of the coating layer is around 40 g/m² on both surfaces in the case of art paper, around 20 g/m² on both surfaces in the case of high-quality coated paper or medium-quality coated paper, around 15 g/m² on both surfaces in the case of high-quality lightweight coated paper or medium-quality lightweight coated paper, and 12 g/m² or less on both surfaces in the case of a light-coated printing paper. An example of an art paper is Tokubishi Art, or the like; an example of a high-quality coated paper is “Urite”; examples of art papers are Tokubishi Art (made by Mitsubishi Paper Mills), Golden Cask Satin (made by Oji Paper), or the like; examples of coated papers are OK Top Coat (made by Oji Paper), Aurora Coat (made by Nippon Paper Group), Recycle Coat T-6 (made by Nippon Paper Group); examples of lightweight coated papers are Urite (made by Nippon Paper Group), New V Matt (made by Mitsubishi Paper Mills), New Age (made by Oji Paper), Recycle Mat T-6 (made by Nippon Paper Group), and “Pism” (made by Nippon Paper Group). Examples of light-coated printing papers are Aurora L (made by Nippon Paper Group) and Kinmari Hi-L (made by Hokuetsu Paper Mills), or the like. Moreover, examples of cast coated papers are: SA Gold Cask plus (made by Oji Paper), Hi-McKinley Art (Gojo Paper Manufacturing), or the like.

The recording media used in the embodiment of the present invention are not limited to the coated paper, and it is possible to use the following recording media. The preferred examples of the recording media include gloss or mat paper such as board paper, cast coated paper, art paper, high-grade paper, copy paper, recycled paper, synthetic paper, wood-containing paper, pressure-sensitive paper, and emboss paper. Special inkjet paper can be also used. Further, resin film and metal deposited film can be also used. More specific preferred examples include paper with a weight of 60 g/m² to 350 g/m² such as OK Ercard+ (manufactured by Oji Paper), SA Kanefuji+ (manufactured by Oji Paper), Satin Kanefuji N (manufactured by Oji Paper), OK Top Coat+ (manufactured by Oji Paper), New Age (manufactured by Oji Paper), Tokuhishi Art Both-sides N (manufactured by Mitsubishi Paper Mills), Tokuhishi Art Single-side N (manufactured by Mitsubishi Paper Mills), New V Mat (manufactured by Mitsubishi Paper Mills), Aurora Coat (manufactured by Nippon Paper Industries), Aurora L (manufactured by Nippon Paper Industries), U-Light (manufactured by Nippon Paper Industries), Recycle Coat T-6 (manufactured by Nippon Paper Industries), Recycle Mat T-6 (manufactured by Nippon Paper Industries), Ivest W (manufactured by Nippon Paper Industries), Invercoat M (manufactured by SPAN CORPORATION), High McKinley Art (manufactured by Gojo Paper Mfg), Kinmari Hi-L (manufactured by Hokuetsu Paper Mills), Signature Tire (manufactured by Newpage Corporation), Sterling Ultra (manufactured by Newpage Corporation), Anthem (manufactured by Newpage Corporation), Hanno ArtSilk (manufactured by Sappi), Hanno Art Gross (manufactured by Sappi), Consort Royal Semimatt (manufactured by Scheufelen), Consort Royal Gross (manufactured by Scheufelen), Zanders Ikono Silk (manufactured by m-real), Zanders Ikono Gross (manufactured by m-real).

### Aqueous Ink

The aqueous ink used in the embodiment of the present invention will be described below in greater detail. The aqueous ink contains at least a resin dispersant (A), a pigment (B) that is dispersed by the resin dispersant (A), self-dispersible polymer particles (C), and an aqueous liquid medium (D).

### <Resin Dispersant (A)>

The resin dispersant (A) is used as a dispersant for the pigment (B) in the aqueous liquid medium (D) and may be any appropriate resin, provided that it can disperse the pigment (B). The preferred structure of the resin dispersant (A) includes a hydrophobic structural unit (a) and a hydrophilic structural unit (b). If necessary, the resin dispersant (A) can also include a structural unit (c) that is different from the hydrophobic structural unit (a) and hydrophilic structural unit (b).

As for the compounding ratio of the hydrophobic structural unit (a) and hydrophilic structural unit (b), it is preferred that the hydrophobic structural unit (a) takes more than 80 wt %, preferably 85 wt % or more of the total weight of the resin dispersant (A). Thus, the compounding ratio of the hydrophilic structural unit (b) has to be not more than 15 wt %. Where the compounding ratio of the hydrophilic structural unit (b) is more than 15 wt %, the amount of component that is independently dissolved in the aqueous liquid medium (D), without participating in the dispersion of the pigment, increases, thereby causing degradation of performance such as dispersivity of the pigment (B) and worsening the ejection ability of ink for inkjet recording.

The preferred specific examples of the resin dispersant (A) used in the embodiment of the present invention are presented below, but the present invention is not limited thereto.

| | | |
|---|---|---|
| 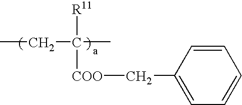 | 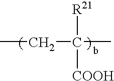 | 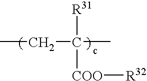 |

| | R¹¹ | R²¹ | R³¹ | R³² | a | b | c | Mw |
|---|---|---|---|---|---|---|---|---|
| B-1 | CH₃ | CH₃ | CH₃ | —CH₃ | 60 | 10 | 30 | 46000 |
| B-2 | H | H | H | —CH₃ | 60 | 10 | 30 | 50000 |
| B-3 | CH₃ | CH₃ | CH₃ | —CH₂CH₃ | 61 | 10 | 29 | 43000 |
| B-4 | CH₃ | CH₃ | CH₃ | —CH₂CH₂CH₂CH₃ | 61 | 9 | 30 | 51000 |
| B-5 | CH₃ | CH₃ | CH₃ | —CH₂(CH₃)CH₃ | 60 | 9 | 31 | 96000 |
| B-6 | H | H | H | —CH₂(CH₃)(CH₃)CH₃ | 60 | 10 | 30 | 32000 |
| B-7 | CH₃ | CH₃ | CH₃ | —CH₂CH(CH₃)CH₃ | 60 | 5 | 30 | 75000 |

(a, b and c represent respective compositions (wt%))

| | |
|---|---|
| 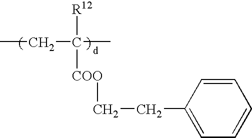 | 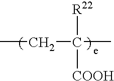 |

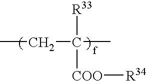

| | R¹² | R²² | R³³ | R³⁴ | d | e | f | Mw |
|---|---|---|---|---|---|---|---|---|
| B- | CH₃ | CH₃ | CH₃ | —CH₃ | 55 | 12 | 33 | 31000 |
| 8 | | | | | | | | |
| B- | H | H | H | —CH2CH(CH3)CH3 | 70 | 10 | 20 | 34600 |
| 9 | | | | | | | | |

(d, e and f represent respective compositions (wt%))

| | |
|---|---|
| 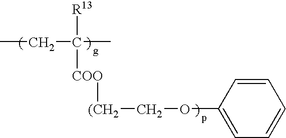 | 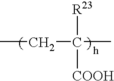 |

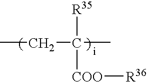

| | R¹³ | p | R²³ | R³⁵ | R³⁶ | g | h | i | Mw |
|---|---|---|---|---|---|---|---|---|---|
| B-10 | CH₃ | 1 | CH₃ | CH₃ | —CH₃ | 60 | 9 | 31 | 35500 |
| B-11 | H | 1 | H | H | —CH₂CH₃ | 69 | 10 | 21 | 41200 |
| B-12 | CH₃ | 2 | CH₃ | CH₃ | —CH₃ | 70 | 11 | 19 | 68000 |
| B-13 | CH₃ | 4 | CH₃ | CH₃ | —CH₂(CH₃)CH₃ | 70 | 7 | 23 | 72000 |
| B-14 | H | 5 | H | H | —CH₃ | 70 | 10 | 20 | 86000 |
| B-15 | H | 5 | H | H | —CH₂CH(CH₃)CH₃ | 70 | 2 | 28 | 42000 |

(g, h and i represent respective compositions (wt%))

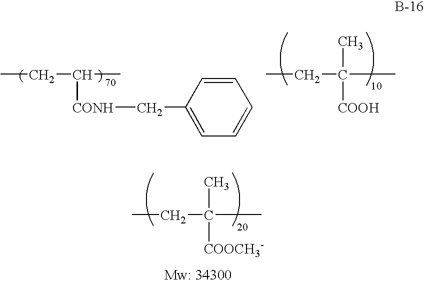

| | | Mw |
|---|---|---|
| B-17 | 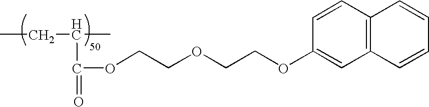 | 72400 |
| | 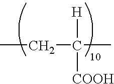 | |
| | 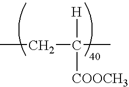 | |
| B-18 | 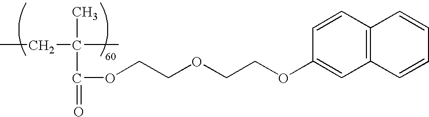 | 33800 |
| | 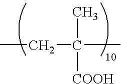 | |
| | 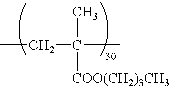 | |
| B-19 | 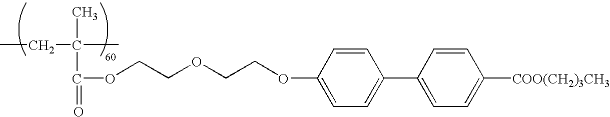 | 39200 |
| | 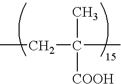 | |
| | 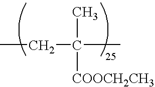 | |
| B-20 | 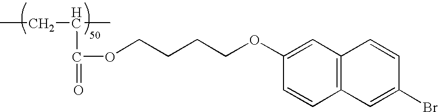 | 55300 |
| | 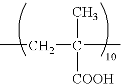 | |
| | 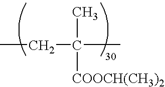 | |

### <Ratio of Pigment (B) and Resin Dispersant (A)>

The weight ratio of the pigment (B) and resin dispersant (A) is preferably 100:25 to 100:140, more preferably 100:25 to 100:50. When the resin dispersant is present at a ratio not lower than 100:25, the dispersion stability and abrasion resistance tend to improve, and where the resin dispersant is present at a ratio of 100:140 or less, the dispersion stability tends to improve.

### <Pigment (B)>

In the embodiment of the present invention, the pigment (B) is a general term for color substances (including white color when the pigment is inorganic) that are practically insoluble in water and organic solvents, as described in Kagaku Daijiten (third edition), published on Apr. 1, 1994, (ed. by Michinori Oki), p. 518, and organic pigments and inorganic pigments can be used in the embodiment of the present invention.

Further, “the pigment (B) dispersed by the resin dispersant (A)” in the description of the embodiment of the present invention means a pigment that is dispersed and held by the resin dispersant (A) and is preferably used as a pigment that is dispersed and held by the resin dispersant (A) in the aqueous liquid medium (D). An additional dispersant may be optionally contained in the aqueous liquid medium (D).

The pigment (B) dispersed by the resin dispersant (A) used in the embodiment of the present invention is not particularly limited, provided that it is a pigment that is dispersed and held by the resin dispersant (A). From the standpoint of pigment dispersion stability and ejection stability, microcapsulated pigments produced by a phase transition method are more preferred from among the aforementioned pigments.

A microcapsulated pigment represents a preferred example of the pigment (B) employed in the embodiment of the present invention. The microcapsulated pigment as referred to herein is a pigment coated by the resin dispersant (A).

The resin of the microcapsulated pigment has to use the resin dispersant (A), but it is preferred that a polymer compound having self-dispersibility or solubility in water and also having an anionic (acidic) group be used in a resin other than the resin dispersant (A).

The following pigments can be used in the embodiment of the present invention. Thus, examples of yellow ink pigments include C. I. Pigment Yellow 1, 2, 3, 4, 5, 6, 7, 10, 11, 12, 13, 14, 14C, 16, 17, 24, 34, 35, 37,42, 53, 55, 65, 73, 74, 75, 81, 83, 93, 95, 97, 98, 100, 101, 104, 108, 109, 110, 114, 117, 120, 128, 129, 138, 150, 151, 153, 154, 155, 180.

Examples of magenta ink pigments include C. I. Pigment Red 1, 2, 3, 4, 5, 6, 7, 8, 9, 10, 11, 12, 13, 14, 15, 16, 17, 18, 19, 21, 22, 23, 30, 31, 32, 37, 38, 39, 40, 48 (Ca), 48 (Mn), 48:2, 48:3, 48:4, 49, 49:1, 50, 51, 52, 52:2, 53:1, 53, 55, 57 (Ca), 57:1, 60, 60:1, 63:1, 63:2, 64, 64:1, 81, 83, 87, 88, 89, 90, 101 (Bengal), 104, 105, 106, 108 (cadmium red), 112, 114, 122 (quinacridone magenta), 123, 146, 149, 163, 166, 168, 170, 172, 177, 178, 179, 184, 185, 190, 193, 202, 209, 219. Among them, C. I. Pigment Red 122 is especially preferred.

Examples of cyan ink pigments include C. I. Pigment Blue 1, 2, 3, 15, 15:1, 15:2, 15:3, 15:4, 16, 17:1, 22, 25, 56, 60, C. I. Vat Blue 4, 60, 63. Among them, C. I. Pigment Blue 15:3 is especially preferred.

Examples of other color ink pigments include C. I. Pigment Orange 5, 13, 16, 17, 36, 43, 51, C. I. Pigment Green 1, 4, 7, 8, 10, 17, 18, 36, C. I. Pigment Violet 1 (Rhodamine Lake), 3, 5:1, 16, 19 (quinacridone red), 23, 28. Processed pigments such as graft carbon that are obtained by treating the pigment surface with a resin or the like can be also used.

Carbon black is an example of a black pigment. Specific examples of carbon black include No. 2300, No. 900, MCF88, No. 33, No. 40, No. 45, No. 52, MA 7, MA8, MA100, and No. 2200B manufactured by Mitsubishi Chemical, Raven 5750, Raven 5250, Raven 5000, Raven 3500, Raven 1255, and Raven 700 manufactured by Colombia, Regal 400R, Regal 1330R, Regal 1660R, Mogul L, Monarch 700, Monarch 800, Monarch 880, Monarch 900, Monarch 1000, Monarch 1100, Monarch 1300, and Monarch 1400 manufactured by Cabot Corp., and Color Black FW1, Color Black FW2, Color Black FW2V, Color Black FW18, Color Black FW200, Color Black S150, Color Black S160, Color Black S170, Printex 35, Printex U, Printex V, Printex 140U, Special Black 6, Special Black 5, Special Black 4A, and Special Black 4 manufactured by Degussa Co., Ltd.

The aforementioned pigments may be used individually or in combinations obtained by selecting a plurality of pigments in each of the above-described groups or a plurality of pigments from different groups.

From the standpoint of dispersion stability and concentration of the aqueous ink, the content ratio of the pigment (B) in the aqueous ink used in the embodiment of the present invention is preferably 1 wt % to 10 wt %, more preferably 2 wt % to 8 wt %, and even more preferably 2 wt % to 6 wt %.

### <Self-Dispersible Polymer Particles (C)>

The aqueous ink used in the embodiment of the present invention includes self-dispersible polymer particles of at least one kind. Self-dispersible polymer particles as referred to herein mean particles of a water-insoluble polymer containing no free emulsifying agent, this water-insoluble polymer being capable of assuming a dispersion state in an aqueous medium under the effect of functional groups (especially acidic groups or salt thereof) of the resin itself, without the presence of another surfactant.

The dispersion state as referred to herein includes both an emulsion state (emulsion) in which the water-insoluble polymer is dispersed in a liquid state in the aqueous medium and a dispersion state (suspension) in which the water-insoluble polymer is dispersed in a solid state in the aqueous medium.

From the standpoint of ink stability and ink aggregation speed in the case the water-insoluble polymer is contained in a water-soluble ink, it is preferred that the water-insoluble polymer used in the embodiment of the present invention be a water-insoluble polymer that can assume a dispersion state in which the water-insoluble polymer is dispersed in a solid state.

The self-dispersible polymer particles used in the embodiment of the present invention include a structural unit derived from a (meth)acrylate monomer including an aromatic group, and the content ratio thereof is preferably 10 wt % to 95 wt %. Where the content ratio of the (meth)acrylate monomer including an aromatic group is 10 wt % to 95 wt %, the stability of self-emulsion or dispersion state is improved. In addition, the increase in ink viscosity can be inhibited.

In the embodiment of the present invention, from the standpoint of stability of the self-dispersion state, stabilization of particle shape in the aqueous medium by hydrophobic interaction of aromatic rings with each other, and decrease in the amount of water-soluble components caused by adequate hydrophobization of the particles, it is preferred that the content ratio of the (meth)acrylate monomer including an aromatic group be 15 wt % to 90 wt %, preferably 15 wt % to 80 wt %, more preferably 25 wt % to 70 wt %.

The self-dispersible polymer particles used in the embodiment of the present invention can be configured, for example, by a structural unit including a monomer having an aromatic group and a structural unit including a monomer having a dissociative group. If necessary, the particles may also include other structural units.

The molecular weight range of the water-insoluble polymer constituting the self-dispersible polymer particles used in the embodiment of the present invention is preferably 3000 to 200,000, more preferably 50000 to 150,000, even more preferably 10,000 to 100,000, as a weight-average molecular weight. Where the weight-average molecular weight is not less than 3000, the amount of water-soluble components can be effectively inhibited. Where the weight-average molecular weight is not more than 200,000, self-dispersion stability can be increased. The weight-average molecular weight can be measured by gel permeation chromatography (GPC).

From the standpoint of controlling the hydrophilicity and hydrophobicity of the polymer, it is preferred that the water-insoluble polymer constituting the self-dispersible polymer particles used in the embodiment of the present invention include a (meth)acrylate monomer including an aromatic group at a copolymerization ratio of 15 wt % to 90 wt %, a monomer including a carboxyl group, and a monomer including an alkyl group, have an acid value of 25 to 100, and have a weight-average molecular weight of 3000 to 200,000, It is even more preferred that the water-insoluble polymer constituting the self-dispersible polymer particles include a (meth)acrylate monomer including an aromatic group at a copolymerization ratio of 15 wt % to 80 wt %, a monomer including a carboxyl group, and a monomer including an allkyl group, have an acid value of 25 to 95, and have a weight-average molecular weight of 5000 to 150,000.

The mean particle size of the self-dispersible polymer particles used in the embodiment of the present invention is preferably within a range of 10 nm to 400 nm, more preferably 10 nm to 200 nm, and even more preferably 10 nm to 100 nm. Particles with a mean size of 10 nm or more are more suitable for manufacture. Where the mean particle size is not more than 400 nm, stability in storage is improved.

The particle size distribution of the self-dispersible polymer particles used in the embodiment of the present invention is not particularly limited, and particles with a wide particle size distribution or a monodisperse particle size distribution may be used. Furthermore, water-insoluble particles of two or more kinds may be used as a mixture.

The mean particle size and particle size distribution of the self-dispersible polymer particles can be measured, for example, by using a light scattering method.

The self-dispersible polymer particles used in the embodiment of the present invention can be advantageously contained in an aqueous ink composition, and the particles of one kind may be used individually, or particles of two or more kinds may be used together.

### <Aqueous Liquid Medium (D)>

In the aqueous ink of the inkjet recording system, the aqueous liquid medium (D) represents a mixture of water and a water-soluble organic solvent. The water-soluble organic solvent (also can be referred to hereinbelow as “solvent medium”) is used as a drying preventing agent, wetting agent, and penetrating agent.

The ink composition uses the water-soluble solvent for the purpose of a drying prevention agent, wetting agent or permeation promoting agent. In particular, in the case of the aqueous ink composition used in the inkjet recording method, it is desirable to use an organic water-soluble solvent, for the purpose of a drying prevention agent, wetting agent or permeation promoting agent.

A drying prevention agent or wetting agent is used with a view to preventing blockages caused by drying of the inkjet ink in the ink ejection ports of the nozzles, and it is desirable to use an organic water-soluble solvent having a lower vapor pressure than water as the drying prevention agent or wetting agent.

Furthermore, it is also preferable to use an organic water-soluble solvent as a permeation promotion agent, in order that the ink composition (the inkjet ink composition in particular) permeates more satisfactorily into the paper.

In the present embodiment, in order to suppress curl, (a) the water-soluble solvent contains 90 wt % or more of water-soluble solvent having the SP value of 27.5 or lower, and contains a compound expressed by the structural formula (1) below. Here, the “water-soluble solvent having the SP value of 27.5 or lower” and the “compound expressed by the structural formula (1)” may be the same substance or different substances.

The SP value (solubility parameter) of the water-soluble solvent described here is a value expressed as the square root of the molecular aggregation energy, and this value can be calculated by the method described by R. F. Fedors in Polymer Engineering Science, 14, p. 147 (1974). The unit is (MPa)^{1/2} and indicates the value at 25° C.

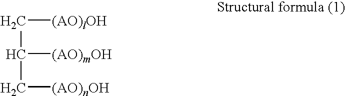

In the structural formula (1), l, m and n are respective and independent natural numbers, and l+m+n=3 to 15.

If l+m+n is less than 3, the curl suppressing force is low, and if this sum is greater than 15, then the ejection characteristics decline.

In the foregoing, desirably, l+m+n is 3 to 12, and more desirably, 3 to 10.

In the structural formula (1), AO represents ethylene oxy and/or propylene oxy, and of these, a propylene oxy group is desirable.

The AO in (AO)ₗ, (AO)ₘ and (AO)ₙ may be respectively the same or different.

The water-soluble organic solvents may be used individually or in mixtures of two or more thereof.

From the standpoint of ensuring stability and ejection characteristic, the content ratio of the water-soluble organic solvent in the ink is preferably not less than 1 wt % and not more than 60 wt %, more preferably not less than 5 wt % and not more than 40 wt %, yet more preferably not less than 10 wt % and not more than 30 wt %.

The amount of water added to the ink is not particularly limited; however, from the standpoint of ensuring stability and ejection characteristic, it is preferably not less than 10 wt % and not more than 99 wt %, more preferably not less than 30 wt % and not more than 80 wt %, and yet more preferably not less than 50 wt % and not more than 70 wt %.

### <Surfactant>

It is preferred that a surfactant (can be also referred to hereinbelow as “surface tension adjusting agent”) be added to the aqueous ink used in the embodiment of the present invention. Examples of surfactants include nonionic, cationic, anionic, and betaine surfactants. The amount of the surface tension adjusting agent added to the ink is preferably such as to adjust the surface tension of the aqueous ink used in the embodiment of the present invention to 20 mN/m to 60 mN/m, more preferably to 20 mN/m to 45 mN/m, and even more preferably to 25 mN/m to 40 mN/m, in order to eject the ink with an ink jet.

A compound having a structure having a combination of a hydrophilic portion and a hydrophobic portion in a molecule can be effectively used as the surfactant, and anionic surfactants, cationic surfactants, amphoteric surfactants, and nonionic surfactants can be used. Furthermore, the above-described polymer substance (polymer dispersant) can be also used as the surfactant.

### <Other Components>

The aqueous ink used in the embodiment of the present invention may also include other additives. Examples of other additives include such well-known additives as an ultraviolet absorbent, a fading preventing agent, an antimold agent, a pH adjusting agent, an antirust agent, an antioxidant, an emulsion stabilizer, a preservative, an antifoaming agent, a viscosity adjusting agent, a dispersion stabilizer, and a chelating agent.

### Treatment Liquid

The aqueous treatment liquid used in the embodiment of the present invention contains at least one solidifying agent which solidifies the components in the aqueous ink. The solidifying agent used in the present embodiment is able to solidify (aggregate) the aqueous ink by making contact with the aqueous ink on the paper. For example, by applying the aqueous treatment liquid, droplets of the aqueous ink are deposited in a state where the solidifying agent is present on the paper and they make contact with the solidifying agent, whereby the component in the aqueous ink can be made to aggregate and solidify on the paper.

Since it is desirable to be able to solidify (aggregate) the aqueous ink, preferably, the treatment liquid is a material that dissolves readily in the aqueous ink upon making contact with the aqueous ink and from this viewpoint, a polyvalent metallic salt having high water solubility is more desirable and an acidic material having high water solubility is also desirable. Furthermore, from the viewpoint of solidifying the whole of the ink by reacting with the aqueous ink, a bivalent or higher-valence acidic material is especially desirable. Moreover, for the solidifying agent, it is also possible to use a cationic compound.

Here, the aggregating reaction of the aqueous ink may be achieved by reducing the dispersion stability of the particles (coloring material (for example, pigment), resin particles, etc.) which are dispersed in the aqueous ink, and causing the overall viscosity of the ink to rise. For example, the surface potential of the particles in the ink, such as pigment and resin particles, which are held in stable dispersion by a weakly acidic functional group, such as a carboxyl group, is lowered by reacting with an acidic material having a lower pKa, thereby reducing the dispersion stability. Hence, the acidic material forming a solidifying agent which is contained in the aqueous treatment liquid is desirably one having a low pKa, high solubility and valence of 2 or above, and more desirably, it is a bivalent or trivalent acidic material having a high buffering capacity in a lower pH region than the pKa of the functional group (for example, carboxyl group) that stabilizes the dispersion of the particles in the ink.

More specific examples are: phosphoric acid, oxalic acid, malonic acid, succinic acid, citric acid, phthalic acid, and the like. Furthermore, it is also possible to use other acidic materials that have similar pKa and solubility to these.

Of these acidic materials, citric acid has a high water retention capability, and tends to produce stronger physical strength of the aggregated ink, and therefore is desirable in situations where further mechanical strength is required. On the other hand, malonic acid, conversely, has a low water retention capability and is desirable in cases where it is wished to accelerate the drying of the treatment liquid.

In this way, the solidifying agent can also be selected appropriately on the basis of further secondary factors, apart from the function of solidifying the aqueous ink.

Possible examples of polyvalent metallic salts are salts of: alkali earth metals of group 2 of the periodic table (for example, magnesium or calcium), transition metals of group 3 of the periodic table (for example, lanthanum), cations from group 13 of the periodic table (for example, aluminum), lanthanides (for example, neodymium).

A desirable example of the cationic compound is a cationic surfactant. Desirably, the cationic surfactant is a primary, secondary or tertiary amine salt compound. Moreover, it is also possible to use an amphoteric surfactant which shows cationic properties in a desired pH range.

It is possible to use either one type or a combination of two or more types of solidifying agent.

The content ratio of the solidifying agent which solidifies the aqueous ink in the aqueous treatment liquid is desirably, 1 wt % to 4 wt %, more desirably, 5 wt % to 30 wt % and even more desirably 10 wt % to 25 wt %.

The aqueous treatment liquid used in the embodiment of the present invention can generally also include, in addition to the solidifying agent, a water-soluble organic solvent, and furthermore, similarly to the aqueous ink, may also contain other additives of various kinds.

Similarly to the aqueous ink, in respect of the water-soluble organic solvent, it is desirable to add water-soluble solvent having an SP value of 27.5 or lower, in order to suppress curl.

The organic solvent described above may be used independently, or a combination of two or more types of organic solvent may be used. Furthermore, desirably, these organic solvents are contained in a range of 1 wt % to 50 wt % in the treatment liquid.

The deposition amount of the solidifying agent is not subject to particular restrictions, provided that it is a sufficient amount to stabilize the aqueous ink, and desirably, the deposition amount is not less than 0.25 g/m², and from the viewpoint of making it easier to solidify the aqueous ink by aggregation, more desirably, it is not less than 0.30 g/m² and less than 2.0 g/m², and even more desirably, not less than 0.40 g/m² and less than 1.0 g/m².

Desirably, the surface tension (at 25° C.) of the aqueous treatment liquid is not lower than 20 mN/m and not higher than 60 mN/m. More desirably, it is not lower than 25 mN/m and not higher than 50 mN/m, and even more desirably, not lower than 25 mN/m and not higher than 45 mN/m. The surface tension is measured using an Automatic Surface Tensionometer CBVP-Z (made by Kyowa Interface Science) with the aqueous treatment liquid at 25° C.

Furthermore, from the viewpoint of achieving stable application in a range of 0.5 ml/m² to 3.5 ml/m², the viscosity of the aqueous treatment liquid at 25° C. is desirably not lower than 1.2 mPa·s and not higher than 15.0 mPa·s, more desirably, not lower than 2 mPa·s and not higher than 12 mPa·s, and even more desirably, not lower than 2 mPa·s and not higher than 8 mPa·s. In particular, when applying the aqueous treatment liquid to paper, the viscosity (at 25° C.) is desirably 2 mPa·s to 8 mPa·s and more desirably, 2 mPa·s to 6 mPa·s. The viscosity is measured using a Viscometer TV-22 (made by Toki Sangyo) with the aqueous treatment liquid at 25° C.

It should be understood, however, that there is no intention to limit the invention to the specific forms disclosed, but on the contrary, the invention is to cover all modifications, alternate constructions and equivalents falling within the spirit and scope of the invention as expressed in the appended claims.

What is claimed is:

1. A liquid application apparatus, comprising:
a drum which holds a sheet-shaped recording medium on a circumferential surface thereof and rotationally conveys the recording medium;
a belt which is wrapped about at least a pair of rollers and makes contact with the recording medium held on the circumferential surface of the drum and rotationally conveyed;
a belt travel device which causes the belt to travel; and
an application liquid supply device which supplies an application liquid to a circumferential surface of the belt,
wherein the application liquid supplied to the circumferential surface of the belt is applied to the recording medium through the belt.

2. The liquid application apparatus as defined in claim 1, wherein the belt travel device causes the belt to travel in a direction opposite to a conveyance direction of the recording medium.

3. The liquid application apparatus as defined in claim 1, wherein the application liquid supply device includes a metering roller which is disposed so as to contact the belt and rotates in a rotational direction opposite to a travel direction of the belt, the application liquid held on a surface of the metering roller being transferred to the circumferential surface of the belt.

4. The liquid application apparatus as defined in claim 3, wherein the application liquid supply device further includes a first doctor blade which scrapes off an excess of the application liquid on the surface of the metering roller, the first doctor blade being disposed to an upstream side of a point of contact between the belt and the metering roller in terms of the rotational direction of the metering roller.

5. The liquid application apparatus as defined in claim 4, wherein the application liquid supply device further includes a second doctor blade which scrapes off the application liquid on the circumferential surface of the belt, the second doctor blade being disposed to an upstream side of the point of contact between the belt and the metering roller in terms of the travel direction of the belt.

6. The liquid application apparatus as defined in claim 1, further comprising a separating device which separates the belt from the circumferential surface of the drum.

7. The liquid application apparatus as defined in claim 1, wherein the belt is an embossed belt having recesses and projections in the circumferential surface thereof.

8. The liquid application apparatus as defined in claim 7, wherein the application liquid supply device includes a doctor blade which scrapes off an excess of the application liquid on the circumferential surface of the belt, the doctor blade being disposed to an upstream side of a point of contact between the belt and the recording medium in terms of the travel direction of the belt.

9. An inkjet recording apparatus, comprising:
a drum which holds a sheet-shaped recording medium on a circumferential surface thereof and rotationally conveys the recording medium;
an endless belt which is wrapped about at least a pair of rollers and makes contact with the recording medium held on the circumferential surface of the drum and rotationally conveyed;
a belt travel device which causes the belt to travel;
a treatment liquid supply device which supplies a treatment liquid to a circumferential surface of the belt; and
an ink ejection device which ejects ink having a solid component that aggregates or precipitates by making contact with the treatment liquid, onto the recording medium on which the treatment liquid has been deposited.

10. The inkjet recording apparatus as defined in claim 9, wherein the belt travel device causes the belt to travel in a direction opposite to a conveyance direction of the recording medium.

11. The inkjet recording apparatus as defined in claim 9, wherein the treatment liquid supply device includes a metering roller which is disposed so as to contact the belt and rotates in a rotational direction opposite to a travel direction of the belt, the treatment liquid held on a surface of the metering roller being transferred to the circumferential surface of the belt.

12. The inkjet recording apparatus as defined in claim 11, wherein the treatment liquid supply device further includes a first doctor blade which scrapes off an excess of the treatment liquid on the surface of the metering roller, the first doctor blade being disposed to an upstream side of a point of contact between the belt and the metering roller in terms of the rotational direction of the metering roller.

13. The inkjet recording apparatus as defined in claim 12, wherein the treatment liquid supply device further includes a second doctor blade which scrapes off the treatment liquid on the circumferential surface of the belt, the second doctor blade being disposed to an upstream side of the point of contact between the belt and the metering roller in terms of the travel direction of the belt.

14. The inkjet recording apparatus as defined in claim 9, further comprising a separating device which separates the belt from the circumferential surface of the drum.

15. The inkjet recording apparatus as defined in claim 9, wherein the belt is an embossed belt having recesses and projections in the circumferential surface thereof.

16. The inkjet recording apparatus as defined in claim 15, wherein the treatment liquid supply device includes a doctor blade which scrapes off an excess of the treatment liquid on the circumferential surface of the belt, the doctor blade being disposed to an upstream side of a point of contact between the belt and the recording medium in terms of the travel direction of the belt.

17. A liquid application method, comprising the steps of:
supplying an application liquid to a surface of a travelling belt;
causing the surface of the belt to which the application liquid has been supplied to make contact with a sheet-shaped recording medium held on a circumferential surface of a drum and rotationally conveyed; and
applying thereby the application liquid to the recording medium through the belt.

18. The liquid application method as defined in claim 17, wherein the belt is caused to travel in a direction opposite to a conveyance direction of the recording medium.

19. The liquid application method as defined in claim 17, wherein the supplying step includes the step of metering the application liquid to be supplied onto the surface of the belt.

20. The liquid application method as defined in claim 17, wherein the supplying step includes the step of metering the application liquid that has been supplied on the surface of the belt.
